(19) United States
(12) Patent Application Publication
(10) Pub. No.: US 2019/0281281 A1
(43) Pub. Date: Sep. 12, 2019

(54) DISPLAY APPARATUS, DISPLAY METHOD, AND PROGRAM

(71) Applicant: SHARP KABUSHIKI KAISHA, Sakai City (JP)

(72) Inventor: HIDEKAZU MIYATA, Sakai City (JP)

(21) Appl. No.: 16/293,333

(22) Filed: Mar. 5, 2019

(30) Foreign Application Priority Data
Mar. 6, 2018 (JP) 2018-039886

(51) Int. Cl. H04N 13/398; H04N 13/344; H04N 5/57; H04N 13/133

(52) U.S. Cl. CPC H04N 13/398; H04N 13/133; H04N 5/57; H04N 13/344

(57) ABSTRACT

An illumination unit, a transmission unit, and a control unit that controls emission luminances of the plurality of light sources based on an input video are provided. The video includes a first video and a second video associated with the first video. Each of the first video and the second video includes a common portion at which a common object is displayed in a form of a stereoscopic video. The control unit determines a correspondence pixel as a pixel of the second video, which represents a common portion with a target pixel as a pixel of the first video, and determines the emission luminance of the light source for each local region such that a luminance difference between a first incoming luminance of light reaching the target pixel and a second incoming luminance of light reaching the correspondence pixel is small.

### BACKGROUND

### 1. Field

The present disclosure relates to a display apparatus, a display method, and a program.

### 2. Description of the Related Art

In the related art, a display apparatus that can be worn on a human body and can be easily carried is proposed as a display apparatus for displaying a stereoscopic video. For example, Japanese Unexamined Patent Application Publication No. 2005-227682 discloses a head mounted display (HMD) that includes left-eye display means for displaying a left-eye image, right-eye display means for displaying a right-eye image, and optical elements which are provided between the left-eye display means and a left eye and between the right-eye display means and a right eye.

It is desired to perceive the depth of an object in order to realize stereoscopic vision. A retinal image difference between the left eye and the right eye is known as a key of depth perception. Since the retinal image difference is close to binocular disparity, the binocular disparity depending on the depth is set in producing a stereoscopic video. Binocular disparity means a difference between a direction of a visual axis (or line of sight) of the left eye and a direction of a visual axis (or line of sight) of the right eye ER when a target object is fixed and seen. The binocular disparity corresponds to an angle between a straight line passing from a target object Obj1 (illustrated in FIG. 18) through the left eye EL and a straight line passing from the target object Obj1 through the right eye ER, for example. Binocular disparities IL1-IR1 and IL2-IR2 depending on the depths of the target objects Obj1 and Obj2 are set between a right-eye video and a left-eye video displayed on a display surface Dq. A user can visually recognize a stereoscopic video from the right-eye video and the left-eye video presented on the right eye and the left eye.

A high dynamic range (HDR) method is proposed as a method for improving image quality of video contents. As the HDR method for television broadcasting, for example, a hybrid log gamma (HLG) method, and a perceptual quantizer (PQ) method are representative. The HDR method is a video transmission method capable of transmission of a video having a luminance in a range wider than a luminance range (hereinafter, standard dynamic range (SDR)) in the related art. For example, the maximum luminance is 1000 to 10000 [nits] in the HDR method, but the maximum luminance is 100 [nits] in the SDR method. As a specification desired for a liquid crystal display corresponding to the HDR method, for example, satisfying criteria that the maximum luminance is equal to or higher than 1000 [nits], and black luminance (minimum luminance) is equal to or lower than 0.05 [nits] (contrast rate [CR] which is 20000:1) is desired. In a liquid crystal display corresponding to the HDR method, a local dimming method may be employed. As disclosed in H. Seetzen, L. A. Whitehead and G. J. Ward, “A High Dynamic Range Display System Using Low and High Resolution Modulators”, Proceedings of the 2003 Society for Information Display Annual Symposium, 54.2, p.1450-1453, May 2003, the local dimming method is a method of controlling a luminance of a light source disposed in each divided region in a backlight divided into a plurality of regions. The liquid crystal display of the local dimming method is expected to spread not only to television reception devices but also to personal computers, multifunctional mobile phones, and other devices, with the popularization of HDR videos.

According to the liquid crystal display of the local dimming method, a luminance of a light source in each of all regions which are lighting regions of the backlight is not controlled all at once but is controlled locally. The local dimming method is as follows. A plurality of light sources is provided in the backlight. The backlight is divided into a plurality of regions (may be referred to as local regions” below), and at least one light source is provided in each of the local regions. Regarding a display image of each frame based on an input video, a luminance (referred to as “an emission luminance” below) of the light source in each of the local regions obtained by division is controlled. In the control method, for example, in a case where a video is displayed with a low luminance in a certain local region of the backlight, the emission luminance of the light source in this local region is set to be reduced in proportion to the minimum luminance as the luminance of a pixel assigned for the input video or to the luminance approximate to the minimum luminance. In this manner, the luminance for display of the pixel in the local region is reduced. In a case where a video is displayed in a state where pixels in a certain local region are set to have a high luminance, the emission luminance of the light source in this local region increases in proportion to the maximum luminance as a value (referred to as “a display luminance value” below) of the luminance of a pixel assigned for the input video or to the luminance approximate to the maximum luminance. In this manner, the video is displayed with increasing the luminance for display of the pixel in the local region. FIG. 19 illustrates an example for display of the liquid crystal display having the local dimming method. In the example illustrated in FIG. 19, a case in which an input video Ih is input is illustrated. In this case, a value proportional to an average value of luminance values of all pixels included in a region corresponding to each light source among all displaying pixels is calculated as an emission luminance Ba of the light source in this region. In a liquid crystal panel of the display, a plurality of pixels through which light coming from each of the light sources of the backlight is transmitted is disposed, and thus light coming from each of the light sources of the backlight is transmitted through the pixels at transmittance Lp. The transmittance Lp of each pixel is determined based on the total intensity of light coming from each of the light sources of the backlight, such that a luminance (referred to as “a display luminance” below) of light emitted to each pixel on the liquid crystal panel is set to be equal to the display luminance value of each of the pixels corresponding to an image constituting the input video Ih (see FIG. 20). Thus, a displayed display Dp is a display of the input video Ih.

Light emitted by a light source disposed at a position corresponding to a pixel or by each light source (may be referred to as “a neighboring light source” below) disposed in the neighboring region of this position reaches each pixel constituting the liquid crystal panel. The position corresponding to a pixel means a position facing the pixel on a surface of the backlight disposed on the back surface. In the example illustrated in FIG. 21, light sources a, b, c, and d correspond to neighboring light sources from which light reaches a target pixel Xᵢⱼ. Thus, the sum of a luminance of light reaching a certain target pixel Xᵢⱼ from the neighboring light sources of the pixel serves as a luminance (may be referred to as “an incoming luminance” below) of light reaching each pixel from the backlight.

In a case of employing the local dimming method, the transmittance at the target pixel Xᵢⱼ in the liquid crystal panel is determined by a value given as a ratio of a luminance value in the target pixel Xᵢⱼ of a video to an incoming luminance.

In a case of displaying a stereoscopic video with a liquid crystal display of the local dimming method as a HMD, a difference of a display luminance may occur between pixels showing a target object which is common between a video presented to the left eye (referred to as “a left-eye video” below) and a video presented to the right eye (referred to as “a right-eye video” below). For example, as illustrated in FIG. 22A, a case where video data representing a left-eye video IhL and a right-eye video IhR is input is assumed. The left-eye video IhL and the right-eye video IhR have rectangular regions (referred to as “bright regions” below) WbL and WbR having a luminance higher than that in the neighboring region thereof. As illustrated in FIGS. 22A to 22C, the region WbL on the left-eye video IhL and the region WbR on the right-eye video IhR have different display positions in displays of the videos IhL and IhR even though the region WbL and the region WbR display the same object. This means that the object in the rectangular region is displayed with a depth differing from that in the background (screen region in which positions of regions other than the rectangular region are not different). Regarding the depth of the object in the case of FIGS. 22A and 22B, the object is displayed in front of the background. However, if the object displayed in front of the background as described above is displayed in the liquid crystal display of the local dimming method, as illustrated in FIG. 22C, a display luminance in a region TgL on a left-eye video DpL displayed in a left-eye display may differ from a display luminance in a region TgR on a right-eye video DpR corresponding to the above region TgL. Such a difference of a display luminance may cause a user to feel uncomfortable. More specifically, the user may recognize the object as not one object obtained by fusion between the left-eye video and the right-eye video as but different individual objects.

The cause of the difference of a luminance is that display positions of the same object in the displays differ from each other by binocular disparity between the left-eye video and the right-eye video. That is, an influence of light coming from the plurality of light sources on target pixels of a portion at which an object is displayed in a right display is different from that on target pixels of a portion at which the object is displayed in a left display.

In a case where the liquid crystal display of the local dimming method performs displaying, the emission luminance of each of the light sources is determined based on the display luminance values of pixels in a range influenced by one light source of the backlight. Since two displays which are a left-eye display and a right-eye display are provided in the HMD, each display independently performs local dimming control on the corresponding backlight. FIG. 22A illustrates an example in which the bright region WbR in the right-eye video IhR is biased to the left relatively to the bright region WbL in the left-eye video IhL. Therefore, the emission luminance of each of the light sources determined based on a display luminance value indicating input video data is also different between a local region in a backlight (referred to as “a left-eye backlight” below) of the left-eye display and the corresponding local region in a backlight (referred to as “a right-eye backlight” below) of the right-eye display. In the example illustrated in FIG. 22B, regarding the emission luminance BaL of each of the light sources in the left-eye backlight and the emission luminance BaR of each of the light sources in the right-eye backlight, regions corresponding to bright regions WbL and WbR respectively indicated by broken lines and the neighboring regions thereof are brighter than other regions. In addition, a region having a high emission luminance BaR in the right-eye backlight is biased to the left relatively to a region having a high emission luminance BaL in the left-eye backlight.

The emission luminance of each of the light sources of the backlight is controlled in a unit of a local region. However, the display luminance of a video is controlled in a unit of a pixel. A relative position relation between a target pixel and the neighboring light source in the left-eye display is different from a relative position relation between a pixel (may be referred to as “a correspondence pixel” below) corresponding to the target pixel and the neighboring light source in the right-eye display. Therefore, in a case where local dimming control is independently performed on the left-eye display and the right-eye display, an incoming luminance at a target pixel in the left-eye display becomes different from an incoming luminance at the correspondence pixel in the right-eye display. Transmittance of a pixel of a liquid crystal panel, which is obtained from an incoming luminance of the plurality of light sources of the backlight and a display luminance value of each pixel indicating input video data is ideally controlled such that a display luminance of a pixel in the left-eye display is equal to a display luminance of the corresponding pixel in the right-eye display. However, in practice, an error occurs in a display luminance of a pixel of the liquid crystal panel between the left-eye display and the right-eye display.

Here, the cause of the error occurring will be described. Generally, transmittance of a pixel is controlled by liquid crystal data indicating a gradation value of each pixel, and the gradation value is digitized. In a case of 8-bit precision, the gradation value is given to be a discrete integer value of 0 to 255 of 256 gradations. In a case of 10-bit precision, the gradation value is given to be a discrete integer value of 0 to 1023 of 1024 gradations. A relation between the gradation value and the transmittance based on gamma characteristics is given by the following expression.

{(gradation value)/(maximum gradation value)}γ=(transmittance−minimum transmittance)/(maximum transmittance−minimum transmittance)

For example, the maximum gradation value is 1023 (=2¹⁰−1) in a case of 10-bit precision and is 255 (=2⁸−1) in a case of 8-bit precision. The maximum transmittance indicates the largest controllable transmittance of a pixel of the liquid crystal panel. The minimum transmittance indicates the smallest controllable transmittance of a pixel of the liquid crystal panel. Further, y is typically a value of 2.0 to 2.6 and is 2.2 in many cases. That is, the transmittance of a pixel in the liquid crystal panel is controlled by “the gradation value” in the above expression, and thus is controlled discretely and nonlinearly with respect to the display luminance. Further, regarding the transmittance of a pixel in the liquid crystal panel, a range in which the transmittance can be controlled is physically limited. The range is limited to about 0.00001% to 10% even though being wide.

With such control characteristics of the transmittance of the liquid crystal panel, errors occur in a display luminance between a plurality of pixels for expressing the same display luminance value. In particular, in a display portion in which a display luminance of an image changes spatially and largely as in the periphery of an outer edge of the bright region WbL or WbR illustrated in FIG. 22A, a luminance coming from the neighboring light source changes largely for each pixel. Thus, in pixels in which the same display luminance value is output, transmittance of the pixel, which is calculated and desired changes larger than that at a position from the neighboring light source. Accordingly, errors occur between the ideally-calculated transmittance and the practical transmittance controlled by a gradation value obtained from the calculated transmittance. Therefore, a display luminance of a portion for expressing a common object differs between the right and left displays. In addition, the transmittance of the liquid crystal panel has viewing-angle dependency. The viewing-angle dependency acts as the cause of causing a difference to occur more between a luminance of video light presented to the left eye from a target pixel and a luminance of video light presented to the right eye from the correspondence pixel.

The HMD includes a lens between the liquid crystal panel and the right eye and between the liquid crystal panel and the left eye, in a state of being mounted on the head of the user. A traveling direction of video light is bent by the lens such that the video light emitted from each of the left display and the right display is recognized as a farther image, and then the video light is incident to each of the left eye and the right eye. Since a distance to the right or left eye from the lens is short, the traveling direction of light output from each pixel is largely bent, and light which is output from each pixel in an inclined direction is also incident to each of the right and left eyes. This situation also acts as the cause of causing the difference to further occur in a luminance which is visually perceived by the right and left eyes from the right and left displays.

The disclosure has been made in consideration of the above circumstances and provides a display apparatus, a display method, and a program in which it is possible to remove or reduce uncomfortable feeling felt by a user who visually recognizes a stereoscopic video. That is, in an embodiment in the disclosure, not local dimming control is independently performed on the backlights of the left-eye display and the right-eye display which have been separated, as in a technology in the related art, but the local dimming control of the backlight of each display is performed in consideration of causing a difference of a display luminance between images of a common portion of a left-eye video and a right-eye video to be sufficiently reduced, with correction.

### SUMMARY

According to an aspect of the disclosure, there is provided a display apparatus including an illumination unit in which a plurality of light sources is disposed and which is divided into a plurality of local regions each including at least one light source, and a transmission unit that controls transmittance of light coming from the illumination unit for each pixel, and a control unit that controls emission luminances of the plurality of light sources based on an input video, for each local region. The video includes a first video and a second video associated with the first video. Each of the first video and the second video includes a common portion at which a common object is displayed in a form of a stereoscopic video. The control unit determines a correspondence pixel as a pixel of the second video, which represents a common portion with a target pixel as a pixel of the first video, and determines the emission luminance of the light source for each local region such that a difference between an incoming luminance of light reaching the target pixel and an incoming luminance of light reaching the correspondence pixel is small.

### BRIEF DESCRIPTION OF THE DRAWINGS

FIG. 1 is a diagram illustrating an example of an exterior configuration of a display apparatus according to a first embodiment;

FIG. 2 is a diagram illustrating an example of a functional configuration of the display apparatus according to the first embodiment;

FIG. 3 is a diagram illustrating an example of video data;

FIGS. 4A and 4B are diagrams illustrating examples of a target pixel and a correspondence pixel;

FIGS. 5A and 5B are diagrams illustrating a method of calculating an incoming luminance;

FIGS. 6A and 6B are diagrams illustrating emission luminance control of a backlight according to the first embodiment;

FIGS. 7A to 7D are diagrams illustrating examples of the emission luminance control of the backlight according to the first embodiment;

FIG. 8 is a side view illustrating an example of a configuration of a display apparatus according to a second embodiment;

FIG. 9 is a front view illustrating the example of the configuration of the display apparatus according to a second embodiment;

FIG. 10 is a diagram illustrating an example of displaying a video by the display apparatus according to the second embodiment;

FIG. 11 is a diagram illustrating an example of a functional configuration of the display apparatus according to the second embodiment;

FIG. 12 is a diagram illustrating a problem of the display apparatus according to the second embodiment;

FIG. 13 is a diagram illustrating an example of a boundary light source and an opposing light source according to the second embodiment;

FIGS. 14A and 14B are diagrams illustrating an example of emission luminance control of a backlight according to the second embodiment;

FIG. 15 is a diagram illustrating an example of a configuration of a display apparatus according to a third embodiment;

FIG. 16 is a diagram illustrating a problem of the display apparatus according to the third embodiment;

FIG. 17 is a diagram illustrating an example of a boundary light source and an opposing light source according to the third embodiment;

FIG. 18 is a diagram illustrating binocular disparity;

FIG. 19 is a diagram illustrating an example of emission luminance control of local dimming control and control of transmittance of a liquid crystal panel, in a display apparatus in the related art;

FIG. 20 is a diagram illustrating an example of a luminance of a video displayed by the display apparatus in the related art;

FIG. 21 is a diagram illustrating an example of the target pixel and a neighboring light source; and

FIGS. 22A to 22C are diagrams illustrating an example of a luminance of a left-eye video and a right-eye video displayed by the display apparatus in the related art.

### DESCRIPTION OF THE EMBODIMENTS

### First Embodiment

Hereinafter, a first embodiment of the disclosure will be described with reference to the drawings.

Firstly, an example of an exterior configuration of a display apparatus 10 according to the embodiment will be described.

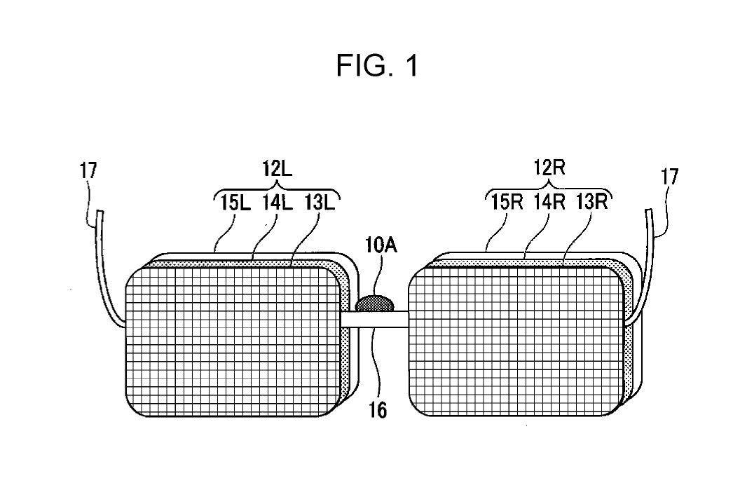

FIG. 1 is a diagram illustrating the example of the exterior configuration of the display apparatus 10 according to the embodiment. The display apparatus 10 is a head mounted display enabled to be mounted on the head of a user.

The display apparatus 10 includes a main body 10A, two display units 12L and 12R, a frame 16, and a mounting unit 17.

The main body 10A is supported by the frame 16 and stores a control unit 11 (which will be described later).

The display units 12L and 12R are supported by the frame 16 and respectively present videos from front surfaces of the left eye and the right eye of the user in a state where the display apparatus 10 is mounted on the head of the user. Each of the display units 12L and 12R is a liquid crystal display. In the following descriptions, the videos presented to the left eye and the right eye may be referred to as a left-eye video and a right-eye video, respectively.

The display unit 12L is configured in a manner that a left-eye liquid crystal panel 14L and a lens 15L overlap a left-eye backlight 13L. The display unit 12R is configured in a manner that a right-eye liquid crystal panel 14R and a lens 15R overlap a right-eye backlight 13R.

The left-eye backlight 13L is divided into a plurality of regions (local regions) obtained by dividing a display region for the left eye. The right-eye backlight 13R is divided into a plurality of regions (local regions) obtained by dividing a display region for the right eye. At least one light source is disposed for each local region.

The left-eye liquid crystal panel 14L and the right-eye liquid crystal panel 14R respectively cause light from light sources disposed in the left-eye backlight 13L and the right-eye backlight 13R to be transmitted therethrough. The left-eye liquid crystal panel 14L and the right-eye liquid crystal panel 14R have variable transmittance for each pixel in the display regions for the left eye and the right eye.

The lens 15L converges light for a left-eye video, which has been transmitted through the left-eye liquid crystal panel 14L. The lens 15R converges light for a right-eye video, which has been transmitted through the right-eye liquid crystal panel 14R.

Thus, the display units 12L and 12R emit light with an independent luminance for each pixel disposed in the display regions, and thus can present a left-eye video and a right-eye video to the left eye and the right eye of a user, respectively, in a state where the user wears the display apparatus 10 on the head.

The frame 16 is a support member that supports the control unit 11 and the display units 12L and 12R. The mounting unit 17 is bonded to both ends of the frame 16.

The mounting unit 17 is a member that is bonded to both the ends of the frame 16, is mounted on the head of the user, and is used for respectively fixing the display units 12L and 12R at positions facing the front of the left eye and the right eye of the user.

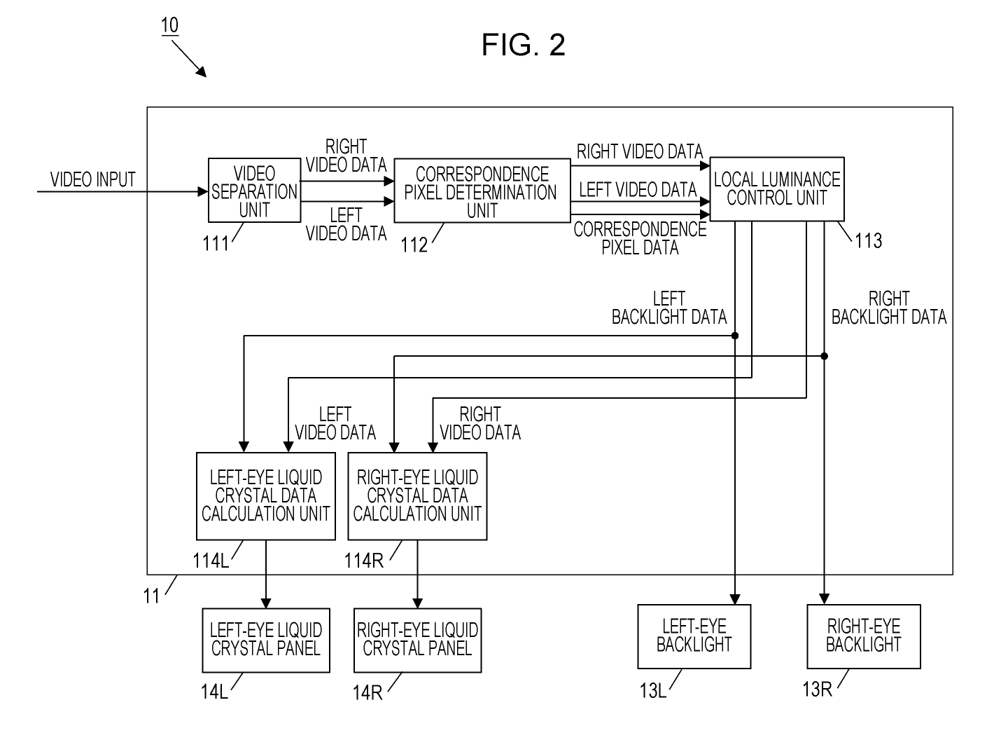

FIG. 2 is a diagram illustrating an example of a functional configuration of the display apparatus 10 according to the embodiment. FIG. 2 illustrates the control unit 11, the left-eye backlight 13L, the right-eye backlight 13R, the left-eye liquid crystal panel 14L, and the right-eye backlight 13R as functional units of the display apparatus 10.

The control unit 11 includes a video separation unit 111, a correspondence pixel determination unit 112, a local luminance control unit 113, a left-eye liquid crystal data calculation unit 114L, and a right-eye liquid crystal data calculation unit 114R.

The control unit 11 may include one or a plurality of control device, for example, a central processing unit (CPU), a graphics processing unit (GPU), and a micro processing unit (MPU). The control unit 11 realizes functions of the video separation unit 111, the correspondence pixel determination unit 112, the local luminance control unit 113, the left-eye liquid crystal data calculation unit 114L, and the right-eye liquid crystal data calculation unit 114R in a manner that the control unit 11 reads an application program (referred to as “an application” below) which has been previously stored in a storage medium provided in the display apparatus 10 and performs processing of which an instruction has been performed by a command described in the read application.

The control unit 11 may include a dedicated IC (for example, application specific integrated circuit (ASIC) and field-programmable array (FPGA)) and the like, which can perform processing of which an instruction has been performed by the application.

Video data (video input) is input to the video separation unit 111. The input video data represents, for example, a video (referred to as “an integrated video” below) in which a left-eye video and a right-eye video in each frame have been arranged in a horizontal direction in this order and have been integrated as with a video Ih illustrated in FIG. 3. An object expressed by the left-eye video and the right-eye video is common. In a case where the input video data is data indicating an HDR video, a gradation value indicating a display luminance value of each pixel is expressed by a 10-bit or 12-bit integer value corresponding to a display luminance of light output from the display units 12L and 12R. For example, in an HLG method, gradation values corresponding to a display luminance value of a black color and a display luminance value of a white color are 64 and 940.

The video separation unit 111 separates video data indicating an integrated video in each frame into left video data indicating a left-eye video and right video data indicating a right-eye video. The left video data and the right video data can also be considered as data indicating time series between frames of the left-eye video and the right-eye video represented by gradation value of each pixel, respectively. The video separation unit 111 outputs the left video data and the right video data obtained by the separation into the correspondence pixel determination unit 112.

The correspondence pixel determination unit 112 compares the left-eye video indicated by the left video data input from the video separation unit 111 and the right-eye video indicated by the right video data input from the video separation unit 111 to each other for each frame. The correspondence pixel determination unit 112 determines a pixel in the right-eye video, which is for displaying a portion of a common object with respect to a pixel constituting the left-eye video, as a correspondence pixel for each pixel. For the correspondence pixel determination unit 112, examples of a method of determining the correspondence pixel include a method of performing determination by performing block matching between the left-eye video and the right-eye video. Block matching means a method of searching for a right block to which a gradation value in each pixel, in which similarity to a gradation value of each pixel in a left block which is a portion of a left-eye video including a target pixel (attracting attentions as a processing target) as a reference pixel is the highest, and the similarity is higher than a predetermined similarity threshold is given, from a right-eye video. As the similarity, for example, index values such as the sum of difference absolute values and the sum of squared differences can be used. The sum of difference absolute values and the sum of squared differences are index values indicating that the similarity becomes higher as the value is reduced. The correspondence pixel determination unit 112 can determine a reference pixel of a right block which can be searched for by block matching, to be a correspondence pixel corresponding to the left-eye video. Here, it is assumed that the sizes and the shapes of the left block and the right block, and relative position relations (for example, center and upper left end) of a reference pixel in the left block and the right block are common with each other, respectively. A difference of a coordinate value in the horizontal direction between the target pixel in a left-eye video and the correspondence pixel in a right-eye video indicates a value (that is, depth from a viewpoint to an object) corresponding to binocular disparity. In the following descriptions, the difference of the coordinate value is referred to as “the number of disparity pixels”.

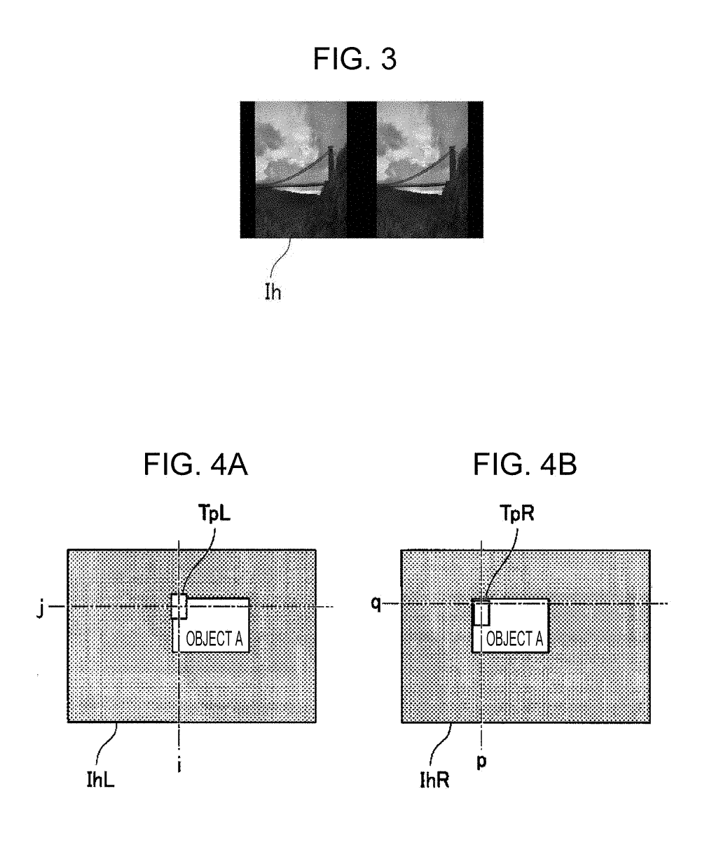

The correspondence pixel determination unit 112 generates correspondence pixel data indicating correspondence pixel information of each target pixel. The correspondence pixel information includes presence information, binocular disparity information, and position information and is set in a format of <“presence information”, “binocular disparity information”, “position information”> for each target pixel, for example. “The presence information” is information indicating the presence of a correspondence pixel. In the embodiment, the presence information may be information indicating whether or not a correspondence pixel relating to an object having, in particular, a depth closer to a viewpoint than a predetermined depth is provided. The presence information is information indicating whether or not a correspondence pixel having binocular disparity to a target pixel, which is greater than predetermined binocular disparity is provided. “The binocular disparity information” may be information indicating the number of disparity pixels between a target pixel and a correspondence pixel, that is, indicating a difference of a coordinate value in the horizontal direction. “The position information” is information indicating coordinates of a correspondence pixel. In the example illustrated in FIGS. 4A and 4B, coordinates of a target pixel TpL and coordinates of a correspondence pixel TpR in a left-eye video IhL and a right-eye video IhR, which represent an object A as a common object are (i, j) and (p, q), respectively. At this time, the correspondence pixel determination unit 112 generates correspondence pixel information of <“1”, “x”, “p, q”> relating to the target pixel TpL. “1” indicates that a correspondence pixel relating to an object closer to a viewpoint than a predetermined depth (for example, 1 m) is provided. Regarding “x”, a difference i-p of a coordinate value in the horizontal direction is set as the number x of disparity pixels indicating binocular disparity information between the target pixel TpL and the correspondence pixel TpR. “p, q” is coordinates of the correspondence pixel TpR in the right-eye video IhR. In a case where a correspondence pixel relating to an object closer to the viewpoint than the predetermined depth is not provided, the correspondence pixel determination unit 112 may set “the presence information” of correspondence pixel information to be “0” and may not set “the binocular disparity information” and “the position information”.

The correspondence pixel determination unit 112 associates the left video data and the right video data which have been input with correspondence pixel data generated for the same frame as the left video data and the right video data and outputs a result of the association to the local luminance control unit 113.

The local luminance control unit 113 determines emission luminances of light sources in each local region of the left-eye backlight 13L and in each local region of the right-eye backlight 13R, based on the left video data, the right video data, and the correspondence pixel data input from the correspondence pixel determination unit 112. The local luminance control unit 113 determines the emission luminance of the light source in each local region such that a difference between an incoming luminance (may be referred to as “a first incoming luminance” below) in each target pixel in the left-eye video and an incoming luminance (may be referred to as “a second incoming luminance” below) in a correspondence pixel in the right-eye video, which corresponds to the target pixel, is very small. The local luminance control unit determines the emission luminance with reference to correspondence pixel data (input from the correspondence pixel determination unit 112) regarding the correspondence pixel of the right-eye video, which corresponds to each target pixel of the left-eye video. The first incoming luminance corresponds to a luminance of light coming from a first neighboring light source. The first neighboring light source is a neighboring light source disposed in a local region in a predetermined range from an in-surface position of a pixel in the left-eye liquid crystal panel 14L. The pixel in the left-eye liquid crystal panel 14L corresponds to the target pixel in the left-eye backlight 13L. The second incoming luminance corresponds to a luminance coming from a second neighboring light source. The second neighboring light source is a neighboring light source disposed in a local region in a predetermined range from an in-surface position of a pixel in the right-eye liquid crystal panel 14R. The pixel in the right-eye liquid crystal panel 14R corresponds to the target pixel in the right-eye backlight 13R.

The local luminance control unit 113 outputs left-eye backlight data to the left-eye backlight 13L and the left-eye liquid crystal data calculation unit 114L. The left-eye backlight data indicates the emission luminance of each light source, which is determined for each local region of the left-eye backlight 13L. The local luminance control unit 113 outputs right-eye backlight data to the right-eye backlight 13R and the right-eye liquid crystal data calculation unit 114R. The right-eye backlight data indicates the emission luminance of each light source, which is determined for each local region of the right-eye backlight 13R. The local luminance control unit 113 outputs left video data and right video data in the same frame as that of the left-eye backlight data and the right-eye backlight data, to the left-eye liquid crystal data calculation unit 114L and the right-eye liquid crystal data calculation unit 114R, respectively. An example of a method of determining a value (referred to as “an emission luminance value” below) of the emission luminance of a light source for each local region, which is indicated by backlight data, will be described later.

The left-eye liquid crystal data calculation unit 114L determines transmittance of each pixel in the left-eye liquid crystal panel 14L based on left backlight data and the left video data input from the local luminance control unit 113. The left-eye liquid crystal data calculation unit 114L outputs left-eye liquid crystal data to the left-eye liquid crystal panel 14L. The left-eye liquid crystal data indicates the determined transmittance of each pixel.

The right-eye liquid crystal data calculation unit 114R determines transmittance of each pixel in the right-eye liquid crystal panel 14R based on right backlight data and the right video data input from the local luminance control unit 113. The right-eye liquid crystal data calculation unit 114R outputs right-eye liquid crystal data to the right-eye liquid crystal panel 14R. The right-eye liquid crystal data indicates the determined transmittance of each pixel. An example of a method of determining transmittance in each pixel will be described later.

In the left-eye backlight 13L and the right-eye backlight 13R, a plurality of light sources is arranged in a plane which is parallel to a display surface for displaying a video.

Regarding each light source in the left-eye backlight 13L, light of the light source is emitted with the emission luminance presented by the left backlight data input from the local luminance control unit 113.

Regarding each light source in the right-eye backlight 13R, light of the light source is emitted with the emission luminance presented by the right backlight data input from the local luminance control unit 113.

Each of the left-eye liquid crystal panel 14L and the right-eye liquid crystal panel 14R includes a liquid crystal layer, two substrates (for example, glass substrates), and a plurality of electrodes. The liquid crystal layer is disposed in a plane parallel to the display surface of a left-eye video and a right-eye video. The two substrates interpose the liquid crystal layer therebetween. The electrodes are arranged on the substrate on a side facing the liquid crystal layer of one substrate.

The electrodes in the left-eye liquid crystal panel 14L apply a voltage to the liquid crystal layer and thus controls transmittance of a portion corresponding to a pixel. The voltage corresponds to transmittance of the pixel relating to the electrode among transmittances of pixels, of which an instruction is performed by the left-eye liquid crystal data input from the left-eye liquid crystal data calculation unit 114L.

The electrodes in the right-eye liquid crystal panel 14R apply a voltage to the liquid crystal layer and thus controls transmittance of a portion corresponding to a pixel. The voltage corresponds to transmittance of the pixel relating to the electrode among transmittances of pixels, of which an instruction is performed by the right-eye liquid crystal data input from the right-eye liquid crystal data calculation unit 114R.

### Method of Determining Emission Luminance of Light Source in Each Local Region

Next, the example of the method of determining the emission luminance of each light source in each local region by the local luminance control unit 113 according to the embodiment will be described.

Firstly, the local luminance control unit 113 determines a value proportional to an average value of the display luminance value indicating the gradation value of each pixel in an input video in regions (may be referred to as “a correspondence region” below) of the left-eye liquid crystal panel 14L and the right-eye liquid crystal panel 14R, which respectively correspond to local regions of the left-eye backlight 13L and the right-eye backlight 13R, to be an initial value (referred to as “an initial adjustment value” below) of the emission luminance value of the light source in the local region corresponding to the correspondence region, for each correspondence region. A method of determining the initial adjustment value of each light source is similar to one method of controlling the emission luminance of a light source in each local region in local dimming control in the related art.

The local luminance control unit 113 adjusts the emission luminance of the light source in each local region such that a luminance difference between the first incoming luminance in each target pixel and the second incoming luminance in the correspondence pixel corresponding to the target pixel is small.

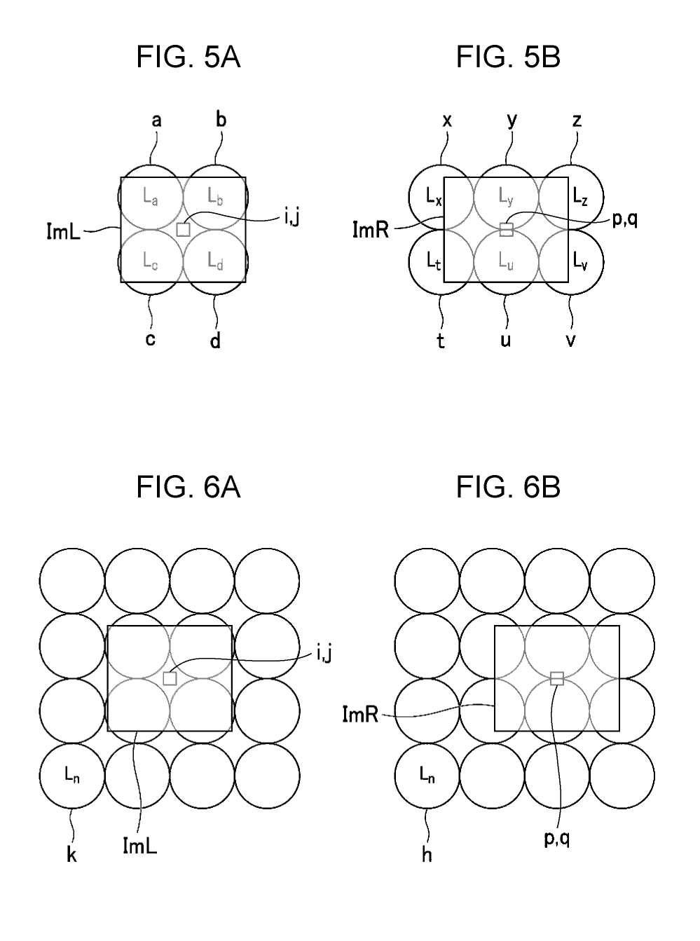

The first incoming luminance corresponds to the sum of a luminance of the first neighboring light source among luminances of the light sources of the local regions, which are indicated by left backlight data. For example, in the example illustrated in FIG. 5A, first neighboring light sources of a target pixel Xᵢⱼ having coordinates of (i, j) in the left-eye liquid crystal panel 14L are light sources a, b, c, and d. The target pixel Xᵢⱼ is one pixel in a expressing an object A as an object, in a left-eye video. The first incoming luminance L_{L, ij} in the target pixel Xᵢⱼ is represented by Expression (1).

$${L}_{L , ij} = {\sum }_{k = a , b , c , d} {W}_{ij , k} \cdot {L}_{k} \qquad ( 1 )$$

In Expression (1), W_{ij, k} indicates a transfer function (weight) from a light source k to the pixel Xᵢⱼ, and Lₖ indicates the light emission luminance of the light source k. That is, the first incoming luminance L_{L, ij} is the sum of the luminance w_{ij, k}·Lₖ from the neighboring light source (k=a, b, c, and d). The luminance w_{ij, k}·Lₖ means a luminance from the light source k, which is obtained by multiplying the emission luminance Lₖ and the transfer function w_{ij, k}.

The second incoming luminance corresponds to the sum of a luminance of the second neighboring light source among luminances of the light sources of the local regions, which are indicated by right backlight data.

For example, in the example illustrated in FIG. 5B, second neighboring light sources of a correspondence pixel X_{pq} having coordinates of (p, q) in the right-eye liquid crystal panel 14R are light sources x, y, z, t, u, and v. The correspondence pixel X_{pq} is one pixel in a region ImR expressing the object A which is common in the region ImL, in a right-eye video. The correspondence pixel X_{pq} is a pixel having a relative position in the region ImR, which is equivalent to a relative position of the target pixel Xᵢⱼ in the region ImL. The second incoming luminance L_{R, pq} in the correspondence pixel X_{pq} is represented by Expression (2).

$${L}_{R , pq} = {\sum }_{h = x , y , z , v , u , t} {W}_{pq , h} \cdot {L}_{h} \qquad ( 2 )$$

In Expression (2), w_{pq}, h indicates a transfer function from a light source h to the pixel X_{pq}.

The local luminance control unit 113 sets the neighboring light source k, the transfer function W_{ij, k}, the neighboring light source h, and the transfer function w_{pq, h} in advance by calculating the neighboring light source k, the transfer function W_{ij, k}, the neighboring light source h, and the transfer function W_{pq, h} of each pixel, which are desired for calculating the incoming luminance L_{back} of the first incoming luminance L_{L, ij} and the second incoming luminance L_{R, pq} described above. The local luminance control unit performs the calculation with light distribution of each light source and a relative position relation between the pixel and the light source.

Ideally, the local luminance control unit 113 may calculate adjustment amounts ΔLₖ and ΔLₕ of a luminance with respect to a luminance Lₖ and Lₕ of the light sources k and h such that the adjusted first incoming luminance L_{L, ij} in the target pixel (i, j) is equal to the second incoming luminance L_{R, pq} in the correspondence pixel (p, q) corresponding to the target pixel (i, j).

However, generally, the number of pixels in the left-eye liquid crystal panel 14L is greater than the number of light sources provided in the left-eye backlight 13L, and the number of pixels in the right-eye liquid crystal panel 14R is greater than the number of light sources provided in the right-eye backlight 13R. Therefore, the adjustment amounts ΔLₖ and ΔLₕ are not uniquely determined. The local luminance control unit 113 calculates the adjustment amounts ΔLₖ and ΔLₕ of the light sources such that a luminance difference ΔL between the adjusted first incoming luminance L′_{L, ij} in the target pixel (i, j) and the second incoming luminance L′_{R, pq} in the correspondence pixel is very small for each display region of a common object between the target pixel and the correspondence pixel, as in Expression (3).

$$δ L = {L}_{L , ij}^{′} - {L}_{R , pq}^{′} \\ {L}_{L , ij}^{′} = {\sum }_{k = a , b , c , d} {w}_{ij , k} \cdot ( {L}_{k} + Δ {L}_{k} ) , \\ {L}_{R , pq}^{′} = {\sum }_{h = x , y , z , v , u , t} {W}_{pq , h} \cdot ( {L}_{h} + Δ {L}_{h} ) \qquad ( 3 )$$

Expression (3) shows that the adjusted first incoming luminance L′_{L, ij} is calculated by the sum of a product of the adjusted emission luminance (Lₖ+ΔLₖ) of the light source k and the transfer function W_{ij, k}. Expression (3) shows that the adjusted second incoming luminance L′L_{R, pq} is calculated by the sum of a product of the adjusted emission luminance (Lₕ+ΔLₕ) of the light source h and the transfer function w_{pq, h}.

The local luminance control unit 113 can use the sum of squares of the luminance difference ΔL of the incoming luminance between the correspondence pixel and the target pixel as the pair of the correspondence pixel, in the display region of pixels for expressing the common object. The local luminance control unit 113 can use the sum of squares of the luminance difference ΔL as an index value for the size of the luminance difference ΔL of the incoming luminance. The local luminance control unit 113 determines the adjustment amount ΔLₖ of the neighboring light source k to which light emitted from each target pixel comes and the adjustment amount ΔLₕ of the neighboring light source h to which light emitted from each correspondence pixel comes, such that the size of the luminance difference ΔL indicated by the index value becomes the smallest.

FIGS. 6A and 6B are diagrams illustrating an example of the light source as a target of adjusting a luminance and the display region of an object. FIG. 6A illustrates 16 neighboring light sources k as targets of adjusting a luminance, which relate to the region ImL for expressing the object A as an object. The neighboring light sources k are light sources that emit light reaching at least any one of target pixels in the region ImL of a left-eye video.

FIG. 6B illustrates 16 neighboring light sources h as targets of adjusting a luminance, which relate to the region ImR for expressing the object A as an object. The neighboring light sources h are light sources that emit light reaching at least any one of target pixels in the region ImR of a right-eye video.

When the display region of an object is specified, the local luminance control unit 113 can determine, for example, the display region of one object in a left-eye video with reference to the correspondence pixel data. The local luminance control unit 113 can a series of regions in which target pixels having presence information indicating that a correspondence pixel is provided are spatially adjacent to each other. The local luminance control unit 113 can determine a region in which correspondence pixels corresponding to target pixels in the determined display region are disposed, to be the display region of the common object in a right-eye video.

If the adjustment amount ΔLₖ of the neighboring light source k and the adjustment amount ΔLₕ of the neighboring light source h that emits light reaching the correspondence pixel are just simply determined such that the size of the luminance difference ΔL of the incoming luminance becomes the smallest, the adjusted emission luminance differs between the neighboring light source k and the neighboring light source h. If the emission luminance between light sources varies significantly, the difference of the display luminance between pixels in a portion for displaying the common object between the display units 12L and 12R may be insufficiently reduced.

Thus, the local luminance control unit 113 may have a condition that the luminance of the light source k and the luminance of the light source h in all local regions relating to the display region of each one object are set to be equal to each other, when calculating the adjustment amount ΔLₖ of the neighboring light source k and the adjustment amount ΔLₕ of the neighboring light source h. Thus, regarding the common object, all emission luminances of the light sources k and h in all local regions relating to the display region become equal to a luminance Ln. Accordingly, the difference of the display luminance in the portion for expressing the common object between the display units 12L and 12R is reduced.

Here, an optical design of a backlight, which includes a mechanism of the backlight and a configuration of the accompanying optical sheet in a liquid crystal display will be described. Regardless of whether or not local dimming control is provided, when a backlight is designed, in a case where the emission luminance from light sources is equal to each other, the optical design is performed in advance such that the sum of the incoming luminance from the neighboring light source is equal in all pixels on the liquid crystal panel.

Thus, as described above, in a case where all emission luminances of all the neighboring light sources k and h relating to the display region of each one object are equal to the luminance Ln, the sum of the incoming luminance of the light source to the pixel has a substantially equal value in all pixels in any of the right and left display regions.

With such a control, the sum of the incoming luminance of light reaching pixels in a portion for displaying an object can be set to be equal.

The index value of the size of the luminance difference δL of the incoming luminance is not limited to the sum of squares and may be an index value of another kind, for example, the sum of absolute values. Similarly, the index value of the size of all the adjustment amounts δLₖ and δLₕ is not limited to the sum of squares and may be an index value of another kind, for example, the sum of absolute values.

### Method of Determining Transmittance

Next, an example of a method of determining transmittance of each pixel in the liquid crystal panel for each of the left eye and the right eye by the left-eye liquid crystal data calculation unit 114L and the right-eye liquid crystal data calculation unit 114R according to the embodiment will be described.

The left-eye liquid crystal data calculation unit 114L calculates an incoming luminance to a pixel, from the emission luminance value of the light source in each local region, which is indicated by the left backlight data input by the local luminance control unit 113.

As represented by Expression (4), the left-eye liquid crystal data calculation unit 114L divides a display luminance value Lᵢⱼ indicating the gradation value of each pixel Xᵢⱼ in left video data input from the local luminance control unit 113 by an incoming luminance L_{back} to the pixel Xᵢⱼ. Thus, the left-eye liquid crystal data calculation unit 114L calculates the quotient obtained by the division, as transmittance Tᵢⱼ. In Expression (4), the unit of the transmittance Tᵢⱼ is %.

Tᵢⱼ=Lᵢⱼ/L_{back}·100 (4)

The right-eye liquid crystal data calculation unit 114R calculates an incoming luminance to a pixel, from the emission luminance value of the light source in each local region, which is indicated by the right backlight data input from the local luminance control unit 113. The right-eye liquid crystal data calculation unit 114R divides a display luminance value L_{pq} indicating the gradation value of each pixel X_{pq} in right video data input from the local luminance control unit 113 by an incoming luminance L_{back} to the pixel X_{pq}. Thus, the right-eye liquid crystal data calculation unit 114R calculates the quotient obtained by the division, as transmittance T_{pq}.

### Example of Emission Luminance Control

Next, an example of emission luminance control of the light source in the backlight by the display apparatus 10 according to the embodiment will be described.

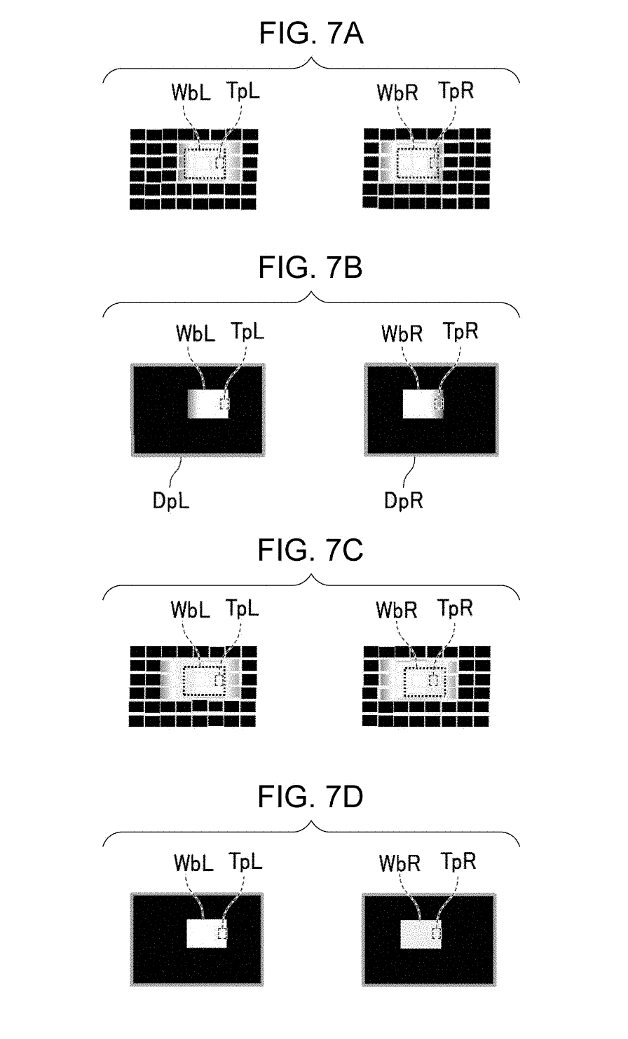

FIGS. 7A to 7D are diagrams illustrating examples of emission luminance control. FIG. 7A illustrates luminance distribution of the left-eye backlight 13L and the right-eye backlight 13R in a case of a local dimming control method in the related art, that is, in a case where an output luminance value of each light source in the left-eye backlight 13L and the emission luminance value of each light source in the right-eye backlight 13R are independently controlled. A rectangular region divided by white lines indicates a local area. A brighter portion indicates a higher emission luminance of the light source in the local region. Rectangles indicated by broken lines indicate display regions WbL and WbR of an object. The emission luminance of a light source for the display region WbL or WbR and the surrounding local region thereof is higher than the emission luminances of light sources in other local regions. A target pixel TpL is illustrated at the center of the right end of the display region WbL. A correspondence pixel TpR corresponding to the target pixel TpL is illustrated at the center of the right end of the display region WbR. The positions of the display region WbR and the correspondence pixel TpR in a right-eye video is biased to the left more than the positions of the display region WbL and the target pixel TpL in a left-eye video. The degree of bias to the left corresponds to the number of disparity pixels.

FIG. 7B illustrates display outputs of the left-eye video and the right-eye video displayed through the left-eye liquid crystal panel 14L and the right-eye liquid crystal panel 14R in a case where the left-eye backlight 13L and the right-eye backlight 13R emit light with the luminances illustrated in FIG. 7A. In the example illustrated in FIG. 7B, a difference of a display luminance occurs between the display regions WbL and WbR for a common object. For example, the luminance of the correspondence pixel TpR is lower than the luminance of the target pixel TpL. The cause is supposed as follows. According to FIG. 7A, the emission luminance of a light source in a local region around the target pixel TpL in the left-eye backlight 13L on the back surface of the target pixel TpL is high. However, in the right-eye backlight 13R on the back surface of the correspondence pixel TpR, there is a local region having a low emission luminance of a light source among local regions around the correspondence pixel TpR. Therefore, light of an amount larger than that to the correspondence pixel TpR reaches the target pixel TpL, and transmittance of the target pixel TpL and transmittance of the correspondence pixel TpR in the liquid crystal panel are controlled to be different from each other. As described above, the transmittance of the liquid crystal panel can be controlled only discretely, and a controllable range is limited. Thus, an error is provided in control of the transmittance in the liquid crystal panel. That is, it is considered that an error in the display luminance occurring by controlling the transmittance of the liquid crystal panel in pixels in which display is performed with the same display luminance value to have different values is the cause of the above phenomenon.

FIG. 7C illustrates luminance distribution of light sources in the left-eye backlight 13L and the right-eye backlight 13R according to the embodiment. Rectangular areas divided by white lines in FIG. 7C represent local areas. FIG. 7D illustrates display outputs of a left-eye video and a right-eye video displayed with light transmitted through the left-eye liquid crystal panel and the right-eye liquid crystal panel in a case of the backlight in FIG. 7C. In the example illustrated in FIGS. 7C and 7D, it is assumed that video data similar to that in FIGS. 7A and 7B is input. That is, the positions of a display region WbL and a target pixel TpL (illustrated in FIGS. 7C and 7D) in the left-eye video and the positions of a display region WbR and a correspondence pixel TpR in the right-eye video are similar to those in the example illustrated in FIGS. 7A and 7B.

In the example illustrated in FIG. 7C, a difference between an incoming luminance to the target pixel in the display region WbL and an incoming luminance to the correspondence pixel in the display region WbR is reduced. In addition, an emission luminance of light sources disposed in a local region corresponding to a pixel in the display region WbL and local regions around the pixel is substantially equal to an emission luminance of light sources disposed in a local region corresponding to a pixel in the display region WbR and local regions around the pixel. In the example illustrated in FIG. 7D, a display luminance difference between pixels corresponding to the display regions WbL and WbR for a common object is reduced. This indicates that a difference of a display luminance between the left-eye video and the right-eye video is reduced. That is, this implies that an uncomfortable feeling of a user, which occurs by the difference of the display luminance between the left-eye video and the right-eye video, is reduced or removed.

As described above, the display apparatus 10 according to the embodiment includes an illumination unit (for example, left-eye backlight 13L and right-eye backlight 13R) in which a plurality of light sources is disposed and which is divided into a plurality of local regions each including at least one light source, a transmission unit (for example, left-eye liquid crystal panel 14L and right-eye liquid crystal panel 14R) that controls transmittance of light coming from the illumination unit for each pixel, a control unit (for example, control unit 11) that determines the emission luminance of the light source for each of the local region by an input video, determines a target pixel as a pixel of a first video (for example, left-eye video) and a correspondence pixel as a pixel of a second video (for example, right-eye video) for displaying a common portion, and determines the luminance of the light source for each local region such that a difference of a first incoming luminance of light reaching the target pixel and a second incoming luminance of light reaching the correspondence pixel is small.

According to the configuration in the embodiment, the difference between the luminance reaching the target pixel and the luminance of light reaching the correspondence pixel (the target pixel and the correspondence pixel represent a common portion) is reduced. Therefore, the difference of the luminance of a pixel in a portion of a common object between a first video and a second video displayed from the transmission unit is also reduced. Thus, the uncomfortable feeling which is felt by the user and may be caused by the difference of the luminance is reduced.

The control unit 11 determines the emission luminance so as to be equal to each other between light sources (neighboring light sources) in local regions in which light reaching a target pixel and a correspondence pixel having disparity (for example, number of disparity pixels) between the target pixel and the correspondence pixel, which is in a predetermined range, is emitted.

According to the configuration in the embodiment, the emission luminance is equal to each other between light sources which relate to displaying of an object and has a distance from a viewpoint, which is in a predetermined range. Since the difference of the display luminance of the pixel for displaying the common portion of an object between the first video and the second video displayed from the transmission unit is further reduced, the uncomfortable feeling which is felt by the user is further reduced.

The control unit 11 determines a value (that is, value obtained by multiplying the average value by a predetermined proportionality factor) proportional to the average value of the luminance (indicated by input video data) of a pixel in a region corresponding to a local region, to be an initial adjustment value of the light source. The control unit 11 adjusts the emission luminance of the light source from the initial adjustment value for each local region.

According to the configuration in the embodiment, it is possible to reduce the adjustment amount of the luminance of each light source in target local regions, and thus the luminance is more reliably controlled.

The display apparatus 10 includes a first video display unit (for example, display unit 12L) that displays a first video and a second video display unit (for example, display unit 12R) that displays a second video. The first video display unit includes a first illumination unit (for example, left-eye backlight 13L) as the illumination unit and a first transmission unit (for example, left-eye liquid crystal panel 14L) as the transmission unit. The second video display unit includes a second illumination unit (for example, right-eye backlight 13R) as the illumination unit and a second transmission unit (for example, right-eye liquid crystal panel 14R) as the transmission unit. In a case where a common object is provided between the first video display unit and the second video display unit, the luminance of a light source in each local region of the first illumination unit and the luminance of a light source in each local region of the second illumination unit are determined such that the luminance difference between a first incoming luminance and a second incoming luminance in a display region for the common object is reduced.

With the configuration in the embodiment, it is possible to provide a user with a stereoscopic video having a wide luminance range and a small uncomfortable feeling.

### Second Embodiment

Next, a second embodiment of the disclosure will be described. The same components as those in the first embodiment are denoted by the same reference signs, and descriptions thereof are employed. The following descriptions will be made focusing on a difference from the first embodiment.

Firstly, an example of a configuration of a display apparatus 20 according to the embodiment will be described.

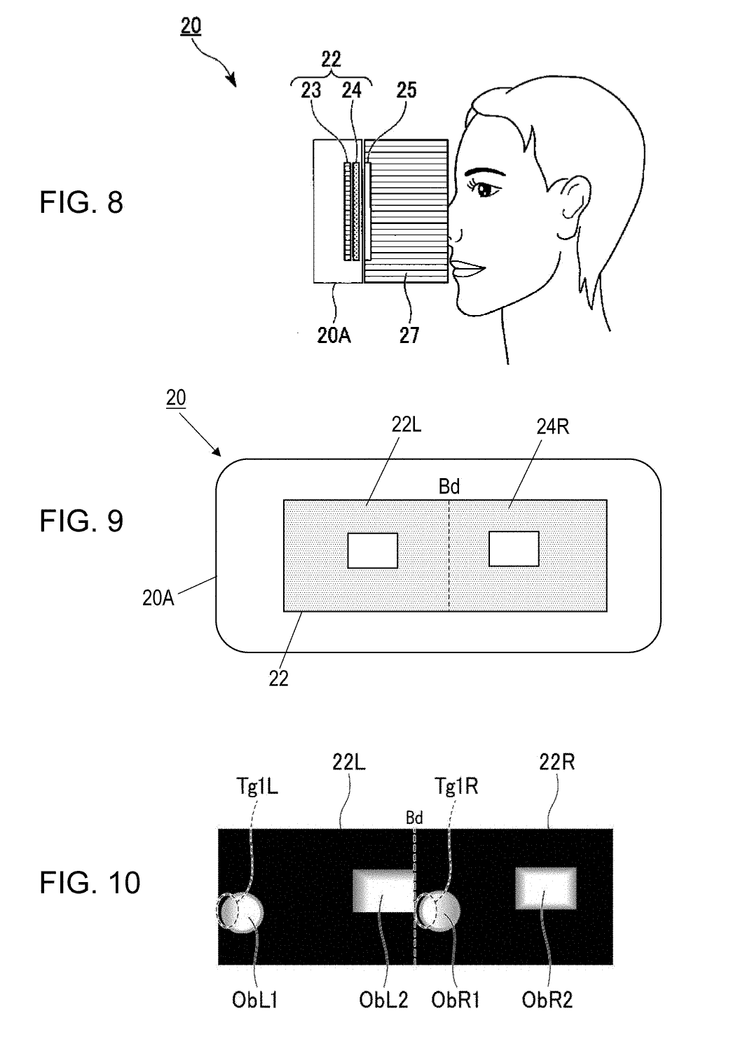

FIG. 8 is a side view illustrating the example of the configuration of the display apparatus 20 according to the embodiment.

The display apparatus 20 includes a main body 20A and a mounting unit 27.

The main body 20A has a housing. A control unit (which will be described later) is stored in the housing. A display unit 22 is provided on the main surface of the main body.

The control unit 21 performs various controls for exhibiting the function of the display apparatus 20. For example, the main body 20A controls the emission luminance of each light source in a backlight 23 (which will be described later) and controls transmittance of each pixel in a liquid crystal panel 24 (which will be described later).

The display unit 22 is a liquid crystal display that separates a stereoscopic video indicated by input video data into a right-eye video and a left-eye video and displays the videos in the right and left on one screen.

The display unit 22 includes the backlight 23 and the liquid crystal panel 24. The backlight 23 is disposed on the back surface of the liquid crystal panel 24. A plurality of light sources is disposed on the surface of the backlight 23 on the liquid crystal panel 24 side. The surface of the backlight 23 is divided into a plurality of local regions. At least one light source among the plurality of light sources is disposed in the local region. The emission luminance of each of the plurality of light sources is controlled in a unit of the local region. The liquid crystal panel 24 changes transmittance for each of a plurality of pixels.

The mounting unit 27 is enabled to be mounted on the head of a user. The mounting unit 27 includes a lens 25 at a position of the display unit 22, which faces the display region, in a state of being mounted on the head of the user. The lens 25 converges the left-eye video and the right-eye video displayed by the display unit 22 in a state where the display unit has been mounted on the head of the user, to the left eye and the right eye, respectively. The mounting unit 27 may include a mounting tool for installing the main body 20A to be attachable. The main body 20A may be not necessarily dedicated for displaying a video. The main body may be an electronic device capable of displaying a video, for example, a multifunctional portable phone (including a so-called smart phone) and a tablet terminal device.

FIG. 9 is a front view illustrating the example of the configuration of the display apparatus 20 according to the embodiment.

A display region set to enable a video to be displayed by the display unit 22 is provided to be parallel to the main surface of the main body 20A. The display region has an elongated shape in which the length of one side is considerably greater than the lengths of other sides.

The display region of the display unit 22 is divided into a left display region 22L for displaying a left-eye video and a right display region 22R for displaying a right-eye video. The left display region 22L and the right display region 22R are arranged in a transverse direction which is a longitudinal direction of the display region, with interposing a boundary Bd therebetween.

The control unit 21 may perform processing similar to the control unit 11 and thus control the emission luminance of each light source such that the left display region 22L and the right display region 22R of the backlight 23 respectively have functions similar to the left-eye backlight 13L (FIG. 2) and the right-eye backlight 13R (FIG. 2) according to the first embodiment. The control unit 21 may control transmittance of each pixel such that the left display region 22L and the right display region 22R of the liquid crystal panel 24 respectively have functions similar to the left-eye liquid crystal panel 14L (FIG. 2) and the right-eye liquid crystal panel 14R (FIG. 2) according to the first embodiment.

However, the display apparatus 20 is different from the display apparatus 10 according to the first embodiment. Light from a light source in the vicinity of a boundary Bd in the right display region 22R reaches a pixel in the vicinity of the boundary Bd among pixels in the left display region 22L. Light from a light source in the vicinity of the boundary Bd in the left display region 22L reaches a pixel in the vicinity of the boundary Bd among pixels in the right display region 22R. In the example illustrated in FIG. 10, light from a light source disposed in a region of an object ObL2 and the surrounding region thereof in the left display region 22L reaches a pixel Tg1R in the vicinity of the boundary Bd in the right display region 22R. The pixel Tg1R is a pixel closest to the boundary Bd among pixels for expressing the object ObR1. A pixel Tg1L corresponds to a target pixel having a correspondence pixel which is set to the pixel Tg1R. The pixel Tg1L is a pixel closest to the left end among pixels for expressing an object ObL1 in a left-eye video. The pixel Tg1L is sufficiently far from the boundary Bd to the left. Thus, light from a light source disposed in the right display region does not reach the pixel Tg1L. The pixel Tg1R is close to the boundary Bd, and thus light from a light source disposed in the left display region 22L reaches the pixel Tg1R. However, the local luminance control unit 113 in the first embodiment does not consider incoming of light from the light source disposed in each of the left display region 22L and the right display region 22R when controlling the emission luminance of each light source in the right-eye backlight 13R and the left-eye backlight 13L in the vicinity of the boundary Bd. Therefore, the luminance in the pixel Tg1L in the left-eye video may differ from the incoming luminance from each light source of the backlight in the pixel Tg1R in the right-eye video. This serves as the cause of causing a user who visually recognizes a stereoscopic video to feel an uncomfortable feeling.

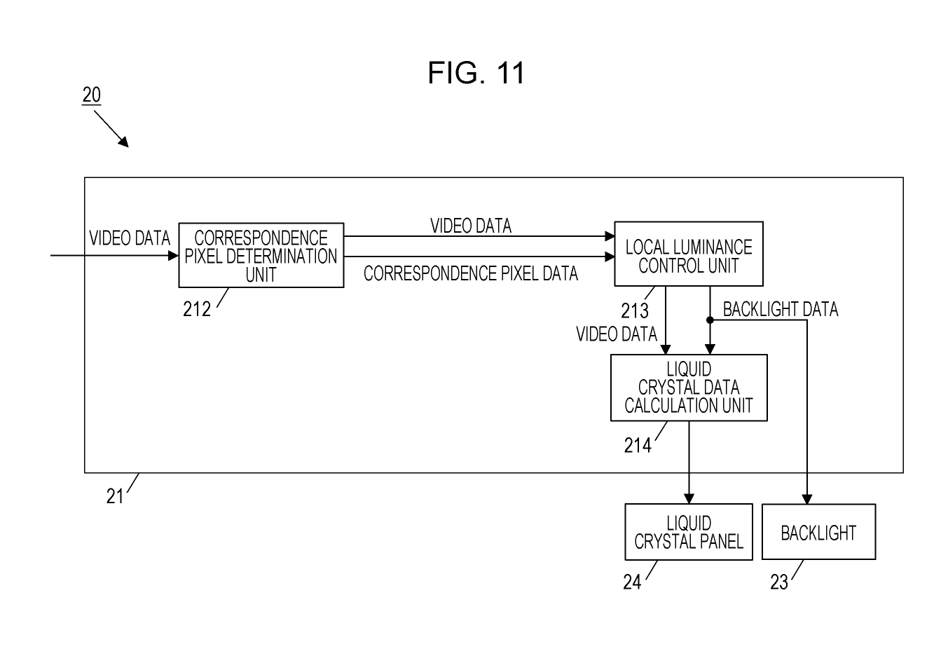

The control unit 21 according to the embodiment includes components described next. As illustrated in FIG. 11, the control unit 21 includes a correspondence pixel determination unit 212, a local luminance control unit 213, and a liquid crystal data calculation unit 214. The control unit 21 may include one or a plurality of control devices. The control device reads an application which has been stored in advance in a storage medium provided in the display apparatus 20. The control device performs processing of which an instruction is performed with a command described in the read application and thus realizes functions of the correspondence pixel determination unit 212, the local luminance control unit 213, and the liquid crystal data calculation unit 214.

The control unit 21 may include a dedicated IC (for example, application specific integrated circuit (ASIC) and field-programmable array (FPGA)) and the like, which can perform processing of which an instruction is performed by the application, in a mechanical manner. In the control unit 21, a functional unit corresponding to the video separation unit 111 (FIG. 2) is omitted.

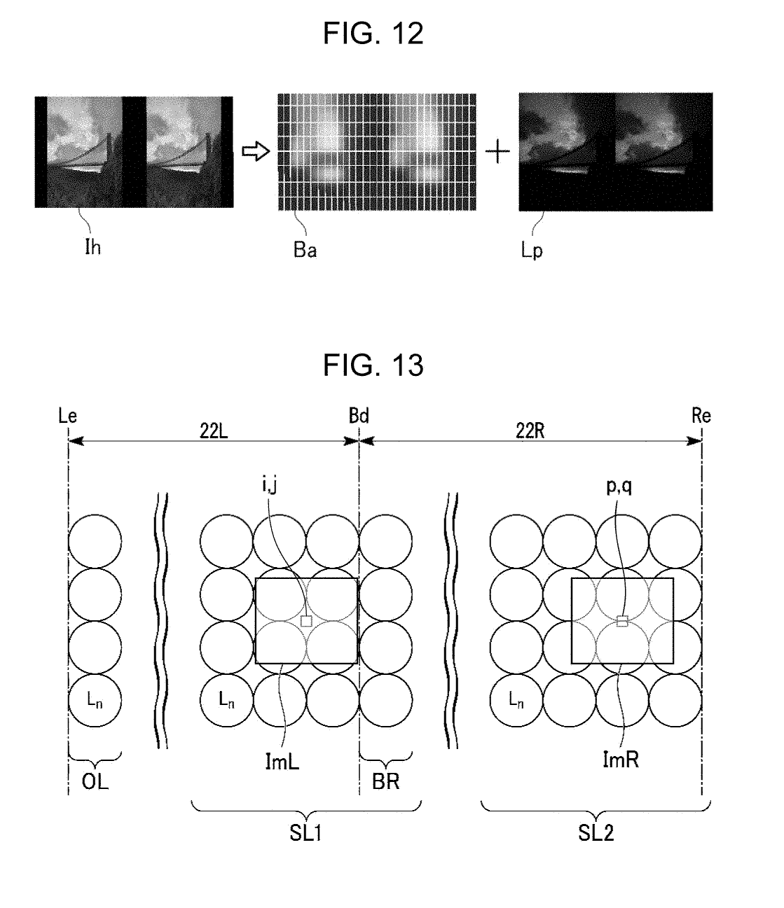

Video data indicating an integrated video in which a left-eye video and a right-eye video have been integrated is input to the correspondence pixel determination unit 212 (FIG. 12, input video Ih). The correspondence pixel determination unit 212 determines a correspondence pixel from the left-eye video and the right-eye video for each target pixel constituting the left-eye video, by a method similar to that in the correspondence pixel determination unit 112. The correspondence pixel determination unit 212 generates correspondence pixel information. The correspondence pixel determination unit 212 generates correspondence pixel data indicating the correspondence pixel information for each target pixel and outputs video data and the generated correspondence pixel data for each frame to the local luminance control unit 213.

The local luminance control unit 213 determines the emission luminance of a light source in each local region in the left display region 22L of the backlight 23 and the emission luminance of a light source in each local region in the right display region 22R. The local luminance control unit 213 performs the determination based on the left-eye video and the right-eye video indicated by the video data input from the correspondence pixel determination unit 212 and the correspondence pixel information of each target pixel, which is indicated by the correspondence pixel data. A method in which the local luminance control unit 213 determines the emission luminance of the light source in each local region corresponds to a method of satisfying the following condition in a method in which the local luminance control unit 113 (FIG. 2) determines the emission luminance of the light source in each local region of the left-eye backlight 13L and the right-eye backlight 13R. The condition is as follows. That is, in a case where a correspondence pixel (or a target pixel associated with the correspondence pixel) relating to an object closer to the viewpoint than a predetermined depth is provided in one region (for example, right display region 22R) of the left display region 22L and the right display region 22R and in a predetermined range from the boundary Bd with the other region (for example, left display region 22L), the local luminance control unit 213 determines the emission luminance of a light source in an opposing local region so as to be equal to the emission luminance of a light source in a local region (referred to as “a local boundary region” below) disposed in the predetermined range. The opposing local region is a local region disposed at a position in one region (for example, left display region 22L), which corresponds to a position in the other region (for example, right display region 22R) in the local boundary region. That is, the opposing local region is disposed at a position (for example, left end) facing the boundary Bd with one region (for example, right display region 22R) on an opposite side in the other region (for example, left display region 22L), in a predetermined range from the opposite side. The local luminance control unit 213 can determine whether or not a correspondence pixel relating to an object closer to the viewpoint than a predetermined depth or a target pixel associated with the correspondence pixel is provided, with reference to the correspondence pixel information input from the correspondence pixel determination unit 212. The correspondence pixel is an element of a common portion representing a common object between the left-eye video and the right-eye video, as described above. The local luminance control unit 213 outputs the input video data to the liquid crystal data calculation unit 214. Regarding the same frame as that in the video data, the local luminance control unit 213 outputs backlight data (FIG. 12, luminance Ba of the backlight) indicating the emission luminance of a light source determined for each local region, to the backlight 23 and the liquid crystal data calculation unit 214. An example of the local boundary region and the opposing local region will be described later.

The liquid crystal data calculation unit 214 calculates the sum of the luminance of light coming from the neighboring light source, which is controlled for each local region in the left display region 22L and is indicated by the backlight data input from the local luminance control unit 213. The liquid crystal data calculation unit 214 determines transmittance of each pixel in the left display region 22L based on the sum of the incoming luminance of each pixel in the left display region 22L and the display luminance value which corresponds to the gradation value of each pixel in the left display region 22L and is indicated by the video data. The liquid crystal data calculation unit 214 performs the calculation for each pixel in the liquid crystal panel 24. A method in which the liquid crystal data calculation unit 214 determines the transmittance of each pixel in the left display region 22L may be similar to the method in which the left-eye liquid crystal data calculation unit 114L (FIG. 2) determines the transmittance of each pixel in the left-eye liquid crystal panel 14L (FIG. 2).

The liquid crystal data calculation unit 214 calculates the sum of the luminance of light coming from the neighboring light source, which is controlled for each local region in the right display region 22R and is indicated by the backlight data input from the local luminance control unit 213. The liquid crystal data calculation unit 214 determines transmittance of each pixel in the right display region 22R based on the sum of the incoming luminance of each pixel in the right display region 22R and the display luminance value which corresponds to the gradation value of each pixel in the right display region 22R and is indicated by the video data. The liquid crystal data calculation unit 214 performs the calculation for each pixel in the liquid crystal panel 24. A method in which the liquid crystal data calculation unit 214 determines the transmittance of each pixel in the right display region 22R may be similar to the method in which the right-eye liquid crystal data calculation unit 114R (FIG. 2) determines the transmittance of each pixel in the right-eye liquid crystal panel 14R (FIG. 2). The liquid crystal data calculation unit 214 outputs liquid crystal data (transmittance Lp of the liquid crystal panel in FIG. 12) indicating the transmittance of each pixel in both the regions, to the liquid crystal panel 24.

In the backlight 23, a plurality of light sources is disposed in a display region in which both the left display region 22L and the right display region 22R are connected to each other. Each light source in the left display region 22L emits light controlled to have an emission luminance value of which an instruction is performed by the backlight data input from the local luminance control unit 213, for each local region. Each light source in the right display region 22R also emits light controlled to have an emission luminance value of which an instruction is performed by the backlight data, for each local region.

In the liquid crystal panel 24, a liquid crystal layer is disposed to be parallel to a display surface on which both the left display region 22L and the right display region 22R are connected to each other. The liquid crystal layer is interposed between two transparent substrates (for example, glass substrates). Thus, a plurality of electrodes is arranged on a side facing the liquid crystal layer on any one substrate of the two transparent substrates. The plurality of electrodes is arranged for each pixel in each of the left display region 22L and the right display region 22R.

The transmittance of a pixel is controlled in a manner that each electrode in the left display region 22L applies a voltage to the liquid crystal layer. The voltage corresponds to the transmittance of the pixel relating to the electrode among transmittances of pixels, which are calculated by the liquid crystal data calculation unit 214 based on the emission luminance value (of which an instruction is performed by the backlight data input from the local luminance control unit 213) of the light source in each local region and the display luminance value corresponding to the gradation value of each pixel, of which an instruction is performed by the video data.

The transmittance of a pixel is controlled in a manner that each electrode in the right display region 22R applies a voltage to the liquid crystal layer. The voltage corresponds to the transmittance of the pixel relating to the electrode among transmittances of pixels, which are calculated by the liquid crystal data calculation unit 214 based on the emission luminance (of which an instruction is performed by the backlight data) of the light source in each local region and the display luminance value corresponding to the gradation value of each pixel, of which an instruction is performed by the video data.

### Example of Boundary Light Source and Opposing Light Source

Next, an example of the boundary light source and the opposing light source according to the embodiment will be described.

FIG. 13 is a diagram illustrating the example of the boundary light source and the opposing light source according to the embodiment.

In the example illustrated in FIG. 13, similar to the example illustrated in FIGS. 6A and 6B, it is assumed that a common object is displayed in a region ImL of the left-eye video and a region ImR of the right-eye video. The neighboring light sources as a control target of the emission luminance for the object by the local luminance control unit 213 (FIG. 11) are light sources SL1 around the region ImR and light sources SL2 around the region ImL, similar to the local luminance control unit 113 (FIG. 2). Most of the neighboring light sources of the light sources SL1 are disposed in the left display region 22L, but some neighboring light sources are disposed in the right display region 22R. The neighboring light sources correspond to the boundary light source BR. In other words, the boundary light source BR is a light source in the right display region 22R among the neighboring light source SL1 to which light emitted to the pixel in the region ImL of the left-eye video comes. The opposing light source OL relating to the object is disposed at a position causing a relative position of the boundary light source BR in the right display region 22R to be the same as a relative position thereof in the left display region 22L. In other words, the opposing light source OL is disposed in a predetermined range from the left end of the left display region 22L, that is, from an opposing side Le which faces the boundary Bd between the left display region 22L and the right display region 22R. The local luminance control unit 213 (FIG. 11) may determine the adjustment amount of the emission luminance of the light source in each local region such that the emission luminances of the opposing light sources OL other than the neighboring light sources SL1 and the neighboring light sources SL2 for display of the object are equal to each other and is equal to the luminance Ln.

In a case where the object is displayed in a region in the predetermined range from the boundary Bd in the right display region 22R, some light source of the neighboring light sources relating to the object are included in the left display region 22L as boundary light sources BL (not illustrated). A light source disposed at a position causing a relative position of the boundary light source BL in the left display region 22L to be equal to a relative position thereof in the right display region 22R is specified as the opposing light source OR (not illustrated). The position of the specified opposing light source OR is disposed in the predetermined range from an opposing side Re which is the right end of the right display region 22R. The local luminance control unit 213 (FIG. 11) determines the adjustment amount of the emission luminance of the light source in each local region such that the emission luminance of the neighboring light source for display the object and the emission luminance of the opposing light source OR are equal to each other and are equal to the luminance Ln.

In accordance with the position of a pixel, whether or not the neighboring light source as the boundary light source is provided, and the opposing light source corresponding to the boundary light source are uniquely determined. Light source setting information may be set in the local luminance control unit 213 (FIG. 11) in advance, for each pixel. The light source setting information includes information regarding whether or not the neighboring light source as the boundary light source is provided and information indicating the opposing light source corresponding to the boundary light source. The local luminance control unit 213 (FIG. 11) can specify the display region of the object by a method similar to that of the local luminance control unit 113 (FIG. 2). In addition, the local luminance control unit 213 can specify whether or not the opposing light source is provided for each pixel in the display region specified with reference to the set light source setting information and specify the opposing light source relating to a pixel determined to have the opposing light source.

### Control Example

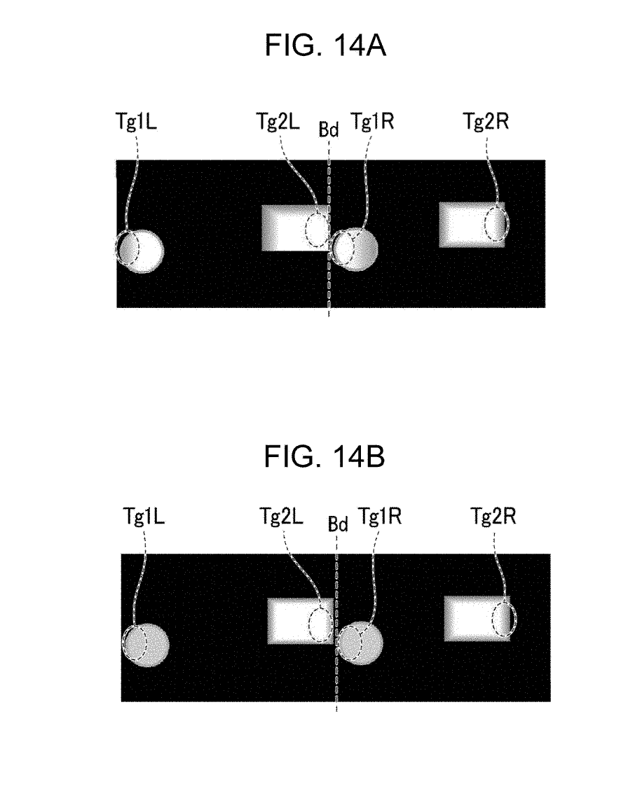

FIGS. 14A and 14B are diagrams illustrating an example of the emission luminance control of the backlight according to the embodiment.

FIG. 14A illustrates a left-eye video and a right-eye video displayed in a case where control is performed with a method similar to the local dimming control method in the related art. That is, FIG. 14A illustrates the left-eye video and the right-eye video displayed through the liquid crystal panel 24 in a case where the emission luminance from each light source in the backlight 23 is independently controlled in the right and left regions for each local region. The left-eye video and the right-eye video are arranged transversely and are displayed in the left display region 22L and the right display region 22R divided by the boundary Bd. Here, the display luminance of a pixel Tg2R in the right display region 22R is higher than the luminance when the video is displayed through the liquid crystal panel 24 in a pixel Tg1L in the left display region 22L. The display luminance of the pixel Tg2L in a predetermined range from the boundary Bd in the left display region 22L is higher than the display luminance of the pixel Tg2R which is the correspondence pixel corresponding to the pixel Tg2L in the right display region 22R.

On the contrary, FIG. 14B illustrates a display example of a video displayed by the display apparatus 20 in the embodiment. In the embodiment, the emission luminance of the light source in each local region is controlled such that the emission luminance from the boundary light source disposed in the predetermined range from the boundary Bd is equal to the emission luminance from the opposing light source disposed at a position having an equal relative position. Therefore, in the video represented by FIG. 14B, the display luminance when light is transmitted through the liquid crystal panel 24 and is presented in the pixel Tg1L in the left display region 22L is substantially equal to the display luminance in the pixel Tg1R in the right display region 22R. The display luminance in the pixel Tg2L in the left display region 22L is substantially equal to the display luminance in the pixel Tg2R in the right display region 22R. As described above, since the display luminance for a portion representing the common object is substantially equal between the left-eye video and the right-eye video, the left-eye video and the right-eye video are perceived as one fused object. Thus, the uncomfortable feeling applied to the user by the difference of the display luminance is removed or reduced.

As described above, the display apparatus 20 according to the embodiment includes a video display unit (for example, display unit 22) which includes an illumination unit (for example, backlight 23) and a transmission unit (for example, liquid crystal panel 24). A region in which the video display unit displays a video is divided into a first region (for example, left display region 22L) in which a first video is presented and a second region (for example, right display region 22R) in which a second video is presented. A control unit (for example, control unit 21) determines the emission luminance of the opposing light source which is a light source disposed at a position in the first region, which corresponds to a position of the boundary light source in the second region, so as to be equal to the emission luminance of the boundary light source which is a light source disposed in the predetermined range from the boundary (for example, boundary Bd) with the first region in the second region, for each local region.

According to the configuration in the embodiment, the first incoming luminance from the light source relating to display of an object to be displayed at a portion close to the boundary of the second region is equal to the second incoming luminance from the light source relating to display of the object to be displayed at a portion of the first region, which corresponds to the above portion. Therefore, a difference between the display luminance of the object displayed at the portion close to the boundary of the second region in the display unit and the display luminance of the object displayed at the portion of the first region, which corresponds to the above portion is further reduced. Thus, an uncomfortable feeling applied to the user by the difference of the display luminance is reduced.

### Third Embodiment

Next, a third embodiment of the disclosure will be described. The same components as those in the second embodiment are denoted by the same reference signs, and descriptions thereof are employed. The following descriptions will be made focusing on a difference from the second embodiment.

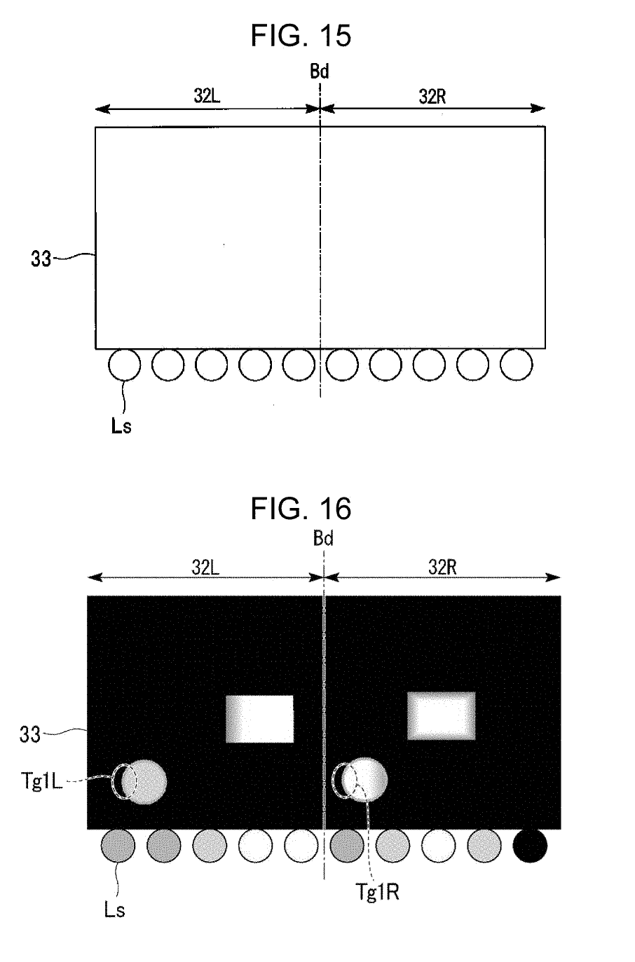

FIG. 15 is a diagram illustrating an example of a configuration of a display apparatus according to the embodiment.

A display apparatus 30 according to the embodiment includes components similar to those of the display apparatus 20. In a display region of a display unit 32 in the display apparatus 30, a left display region 32L and a right display region 32R are connected to each other in a longitudinal direction, with interposing the boundary Bd. A backlight 33 in the display apparatus 30 is configured as an edge backlight in which a plurality of light sources Ls is one-dimensionally arranged along one side parallel to the transverse direction which is a longitudinal direction of the main surface of the backlight. Each of the light sources Ls radiates light in a vertical direction which is a direction intersecting the longitudinal direction. Therefore, it is possible to reduce the thickness of the backlight 33 in comparison to the backlight 23 (FIG. 11) in which the plurality of light sources is two-dimensionally arranged. Therefore, it is possible to reduce the thickness of the entirety of the display apparatus 30. In the embodiment, the emission luminance control of each light source is not two-dimensional differing from the backlight 23 according to the second embodiment, is but one-dimensional control depending on the position of the backlight 33 in the longitudinal direction, which corresponds to the disposition of each light source. In the third embodiment, similar to the second embodiment, the backlight 33 is divided into a plurality of local regions and has at least one light source in each local region. The emission luminance of each light source in each local region is controlled. FIG. 15 illustrates a case where one light source is provided for each local region, as an example.

If the emission luminance of the light source in each local region is controlled independently in a left-eye video and a right-eye video for each frame, by a method similar to the local dimming control method in the related art, the display luminance of a portion representing a common object is different between the left-eye video and the right-eye video. In the example illustrated in FIG. 16, the display luminance displayed through the liquid crystal panel 24 in the pixel Tg1R in the vicinity of the boundary Bd in the right display region 32R is different from the display luminance in the pixel Tg1L which is the target pixel having a correspondence pixel which is set to be the pixel Tg1R. This serves as the cause of applying an uncomfortable feeling to a user who visually recognizes a stereoscopic video.

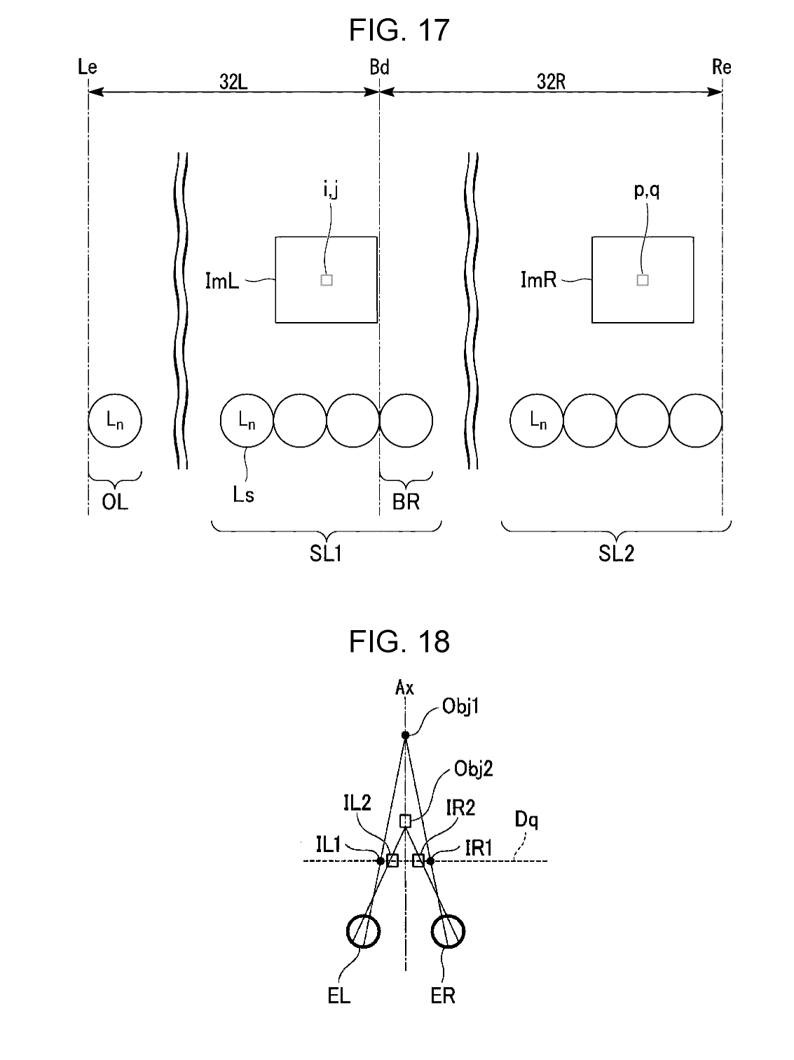

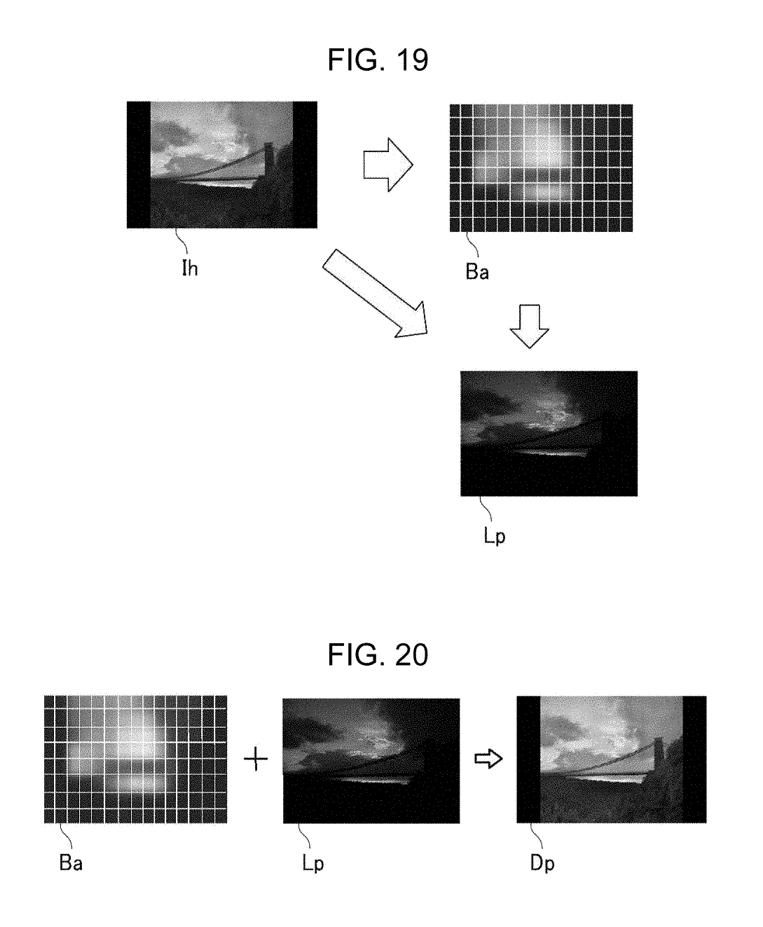

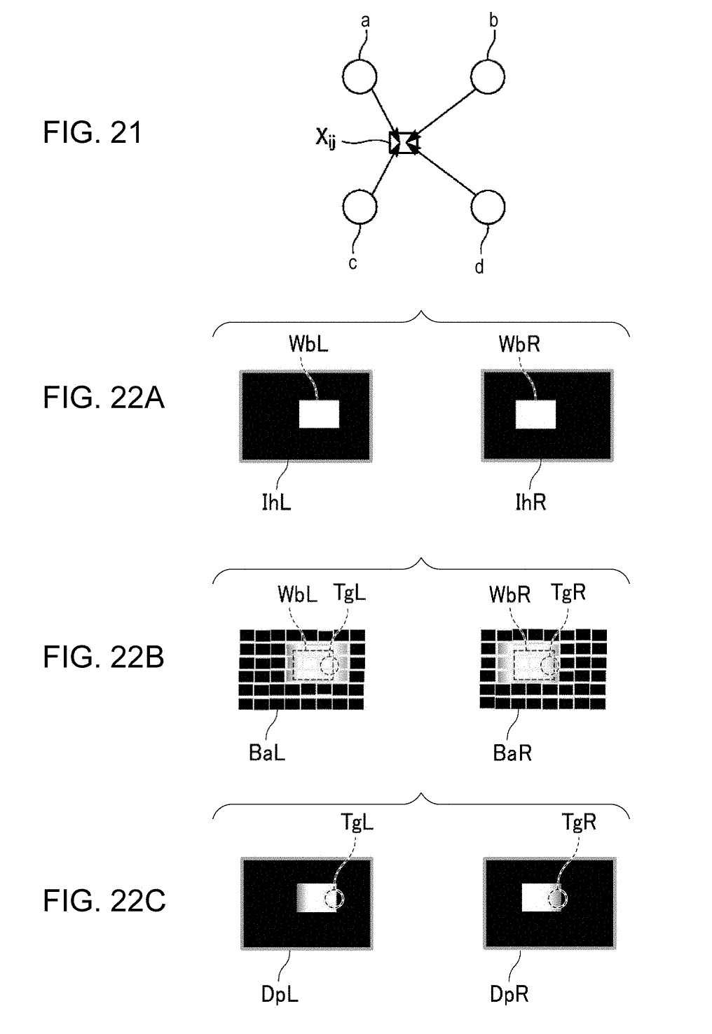

A local luminance control unit 313 (not illustrated) of the display apparatus 30 controls the emission luminance of each local region by a method similar to the local luminance control unit 213 in the display apparatus 20. That is, the local luminance control unit 313 performs a method of satisfying the following condition in the method in which the local luminance control unit 113 (FIG. 2) determines the emission luminance in each local region of the left-eye backlight 13L (FIG. 2) and the right-eye backlight 13R (FIG. 2). The condition is as follows. That is, the local luminance control unit 313 determines the emission luminance of an opposing light source (for example, opposing light source OL in FIG. 17) so as to be equal to the luminance Ln of a boundary light source (for example, boundary light source BR in FIG. 17) disposed in a predetermined range from the boundary Bd with one region (for example, left display region 32L in FIG. 17) in one region (for example, right display region 32R in FIG. 17) of the left display region 32L and the right display region 32R. Since the disposition of the light sources in the backlight 33 is different from that in the second embodiment, information indicating the light source to which light emitted to each pixel comes in accordance with the disposition, information indicating a transfer function from the light source to each pixel, information indicating whether or not the neighboring light source as the boundary light source is provided for each pixel, and information indicating the opposing light source corresponding to the boundary light source are set in the local luminance control unit 313 (not illustrated) in advance.

As described above, in the embodiment, in an illumination unit (for example, backlight 33), a first region (for example, left display region 32L) and a second region (for example, right display region 32R) have a plurality of light sources arranged along one side of the whole display region including the first region and the second region.

According to the configuration of the embodiment, the emission luminance of each light source is controlled such that the emission luminance of the boundary light source disposed in the predetermined range from the boundary Bd is equal to the emission luminance of the opposing light source disposed at a position having an equal relative position. Therefore, in a video displayed by the display apparatus 30, the display luminance of a portion representing an object in the left display region 32L is substantially equal to the display luminance of a portion representing the object in the right display region 32R. Thus, it is possible to reduce the thickness of the display apparatus 30 according to the embodiment, and an uncomfortable feeling applied to a user by the difference of the display luminance between the left display region 32L and the right display region 32R is reduced.

Hitherto, the embodiments of the disclosure are described in detail with reference to the drawings. However, the specific configuration is not limited to the above descriptions, and various design modifications can be made in a range without departing from the gist of the disclosure.

For example, a case where the display apparatuses 10, 20, and 30 according to the above-described embodiments have a fundamental purpose of displaying a stereoscopic video is described as an example. However, the display apparatus may be integrated with an electronic device having a fundamental purpose which is set to be other functions (for example, communication, broadcast reception, and document creation).

In the above-described embodiment, a case where a pixel for displaying a left-eye video is set to a target pixel, and a pixel for displaying a right-eye video is set to a correspondence pixel or a candidate thereof is described as an example. However, a pixel for displaying a right-eye video may be set to a target pixel, and a pixel for displaying a left-eye video may be set to a correspondence pixel or a candidate thereof.

In the above-described embodiments, a case where, when the local luminance control unit 113, 213, or 313 determines the display region of an object, the local luminance control unit performs determination of two stages of whether or not binocular disparity between pixels is greater than a predetermined threshold is described as an example. However, it is not limited thereto. The local luminance control unit 113, 213, or 313 may determine a stage to which the number of disparity pixels among pixels belong among the number of disparity pixels having a plurality of stages which has been preset and is three stages or more. The local luminance control unit 113, 213, or 313 may determine a region formed with a series of pixel sets in which the number of disparity pixels belongs to a common stage, to be a display region for one object. The local luminance control unit 113, 213, or 313 may not determine a region formed with a series of pixel sets in which the number of disparity pixels belongs to a first stage, to be a display region of the object. Here, the first stage refers to the minimum range of the number of disparity pixels, in which the number of disparity pixels is 0 to a first threshold, in a range of the number of disparity pixels having a plurality of stages.

In the first embodiment, a case where the display unit is a mirror-type display is described as an example. However, if the display unit that displays a left-eye video to the left eye and the display unit that displays a right-eye video to the right eye are independent from each other, the display unit may be an immersive display.

The disclosure can be implemented in forms as follows.

(1) A display apparatus including: an illumination unit in which a plurality of light sources is disposed and which is divided into a plurality of local regions each including at least one light source, a transmission unit that controls transmittance of light coming from the illumination unit for each pixel, and a control unit that controls emission luminances of the plurality of light sources based on an input video. The video includes a first video and a second video associated with the first video. Each of the first video and the second video includes a common portion at which a common object is displayed in a form of a stereoscopic video. The control unit determines a correspondence pixel as a pixel of the second video, which represents a common portion with a target pixel as a pixel of the first video, and determines the emission luminance of the light source for each local region such that a luminance difference between a first incoming luminance of light reaching the target pixel and a second incoming luminance of light reaching the correspondence pixel is small.

(2) In the display apparatus in (1), the first video and the second video have disparity corresponding to a depth of the object displayed at each common portion. The control unit determines the emission luminance of the plurality of light sources providing light reaching the target pixel and the correspondence pixel for each local region such that an incoming luminance of light reaching the target pixel is equal to an incoming luminance of light reaching the correspondence pixel, the target pixel and the correspondence pixel having disparity in a predetermined range.

(3) In the display apparatus in (1) or (2), the control unit determines a value proportional to an average value of a display luminance of a pixel in the local region, which is expressed by video data of the video, to be an initial adjustment value, and adjusts the emission luminance of the light source in the local region from the initial adjustment value for each local region.

(4) The display apparatus in any of (1) to (3) further including: a first video display unit that displays the first video, and a second video display unit that displays the second video. The first video display unit includes a first illumination unit as the illumination unit and a first transmission unit as the transmission unit. The second video display unit includes a second illumination unit as the illumination unit and a second transmission unit as the transmission unit. The control unit determines the emission luminance of the light source for each local region of the first illumination unit and an emission luminance of the light source for each local region of the second illumination unit such that the luminance difference is reduced.

(5) The display apparatus in any of (1) to (3) further including: a video display unit that includes the illumination unit and the transmission unit. A region in which the video display unit displays a video is divided into a first region in which the first video is presented and a second region in which the second video is presented. The control unit determines an emission luminance of a first opposing light source which is a light source disposed at a position in the first region, which corresponds to a position of a first boundary light source which is a light source disposed in a predetermined range, in the second region, so as to be equal to an emission luminance of the first boundary light source when the common portion is included in the second region and in the predetermined range from a boundary with the first region, and determines an emission luminance of a second opposing light source which is a light source disposed at a position in the second region, which corresponds to a position of a second boundary light source which is a light source disposed in a predetermined range, in the first region, so as to be equal to an emission luminance of the second boundary light source when the common portion is included in the first region and in the predetermined range from a boundary with the second region.

(6) In the display apparatus in (5), the illumination unit includes a plurality of light sources which has been one-dimensionally arranged along one side of the display region in a direction in which the first region and the second region are lined up, as the plurality of light sources.

(7) A display method of a display apparatus which includes an illumination unit in which a plurality of light sources is disposed, and which is divided into a plurality of local regions each including at least one light source and a transmission unit that controls transmittance of light coming from the illumination unit for each pixel, the method including: controlling emission luminances of the plurality of light sources based on an input video. The video includes a first video and a second video associated with the first video. Each of the first video and the second video includes a common portion at which a common object is displayed in a form of a stereoscopic video. The controlling includes determining a target pixel as a pixel of the first video and a correspondence pixel as a pixel of the second video, which represents a common portion and determining the emission luminance of the light source for each local region such that a luminance difference between a first incoming luminance of light reaching the target pixel and a second incoming luminance of light reaching the correspondence pixel is small.

(8) A program causing a computer of a display apparatus including an illumination unit in which the plurality of light sources is disposed, and which is divided into a plurality of local regions each including at least one light source and a transmission unit that controls transmittance of light coming from the illumination unit for each pixel, to execute controlling emission luminances of a plurality of light sources based on an input video. The video includes a first video and a second video associated with the first video. Each of the first video and the second video includes a common portion at which a common object is displayed in a form of a stereoscopic video. The controlling includes determining a target pixel as a pixel of the first video and a correspondence pixel as a pixel of the second video, which represents a common portion and determining the emission luminance of the light source for each local region such that a luminance difference between a first incoming luminance of light reaching the target pixel and a second incoming luminance of light reaching the correspondence pixel is small.

The portion of the display apparatus 10, 20, or 30, for example, the control unit 11, 21, or 31 (not illustrated) may be realized by a computer. In this case, a program for realizing the control function may be recorded in a computer-readable recording medium. The function may be realized by reading and executing the program recorded in the recording medium in a computer system.

A portion or the entirety of the display apparatus 10, 20, or 30 in the above-described embodiment may be realized in a form of an integrated circuit such as large scale integration (LSI). Each functional block as a portion of the display apparatus 10, 20, or 30 may be individually realized as a processor. Some or all blocks may be integrated so as to be realized as a processor. A method of making an integrated circuit is not limited to LSI, and the integrated circuit may be realized by a dedicated circuit or a general-purpose processor. In a case where an integrated circuit technology to replace LSI appears by an advance in the semiconductor technology, an integrated circuit based on the technology may be used.

The present disclosure contains subject matter related to that disclosed in Japanese Priority Patent Application JP 2018-039886 filed in the Japan Patent Office on Mar. 6, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
an illumination unit in which a plurality of light sources is disposed, and which is divided into a plurality of local regions each including at least one light source;
a transmission unit that controls transmittance of light coming from the illumination unit for each pixel; and
a control unit that controls emission luminances of the plurality of light sources based on an input video,
wherein the video includes a first video and a second video associated with the first video,
each of the first video and the second video includes a common portion at which a common object is displayed in a form of a stereoscopic video, and
the control unit
determines a correspondence pixel as a pixel of the second video, which represents a common portion with a target pixel as a pixel of the first video, and
determines the emission luminance of the light source for each local region such that a luminance difference between a first incoming luminance of light reaching the target pixel and a second incoming luminance of light reaching the correspondence pixel is small.

2. The display apparatus according to claim 1,
wherein the first video and the second video have disparity corresponding to a depth of the object displayed at each common portion, and
the control unit determines the emission luminance of the plurality of light sources providing light reaching the target pixel and the correspondence pixel for each local region such that an incoming luminance of light reaching the target pixel is equal to an incoming luminance of light reaching the correspondence pixel, the target pixel and the correspondence pixel having disparity in a predetermined range.

3. The display apparatus according to claim 1,
wherein the control unit
determines a value proportional to an average value of a display luminance of a pixel in the local region, which is expressed by video data of the video, to be an initial adjustment value, and
adjusts the emission luminance of the light source in the local region from the initial adjustment value for each local region.

4. The display apparatus according to claim 1, further comprising:
a first video display unit that displays the first video; and
a second video display unit that displays the second video,
wherein the first video display unit includes a first illumination unit as the illumination unit and a first transmission unit as the transmission unit,
the second video display unit includes a second illumination unit as the illumination unit and a second transmission unit as the transmission unit, and
the control unit determines the emission luminance of the light source for each local region of the first illumination unit and an emission luminance of the light source for each local region of the second illumination unit such that the luminance difference is reduced.

5. The display apparatus according to claim 1, further comprising:
a video display unit that includes the illumination unit and the transmission unit,
wherein a display region in which the video display unit displays a video is divided into a first region in which the first video is presented and a second region in which the second video is presented, and
the control unit
determines an emission luminance of a first opposing light source which is a light source disposed at a position in the first region, which corresponds to a position of a first boundary light source which is a light source disposed in a predetermined range, in the second region, so as to be equal to an emission luminance of the first boundary light source when the common portion is included in the second region and in the predetermined range from a boundary with the first region, and
determines an emission luminance of a second opposing light source which is a light source disposed at a position in the second region, which corresponds to a position of a second boundary light source which is a light source disposed in a predetermined range, in the first region, so as to be equal to an emission luminance of the second boundary light source when the common portion is included in the first region and in the predetermined range from a boundary with the second region.

6. The display apparatus according to claim 5,
wherein the illumination unit includes a plurality of light sources which has been one-dimensionally arranged along one side of the display region in a direction in which the first region and the second region are lined up, as the plurality of light sources.

7. A display method of a display apparatus which includes an illumination unit in which a plurality of light sources is disposed, and which is divided into a plurality of local regions each including at least one light source and a transmission unit that controls transmittance of light coming from the illumination unit for each pixel, the method comprising:
controlling emission luminances of the plurality of light sources based on an input video,
wherein the video includes a first video and a second video associated with the first video,
each of the first video and the second video includes a common portion at which a common object is displayed in a form of a stereoscopic video,
the controlling includes
determining a target pixel as a pixel of the first video and a correspondence pixel as a pixel of the second video, which represents a common portion, and
determining the emission luminance of the light source for each local region such that a luminance difference between a first incoming luminance of light reaching the target pixel and a second incoming luminance of light reaching the correspondence pixel is small.

8. A program causing a computer of a display apparatus to execute controlling emission luminances of a plurality of light sources based on an input video, the display apparatus including an illumination unit in which the plurality of light sources is disposed, and which is divided into a plurality of local regions each including at least one light source and a transmission unit that controls transmittance of light coming from the illumination unit for each pixel,
wherein the video includes a first video and a second video associated with the first video,
each of the first video and the second video includes a common portion at which a common object is displayed in a form of a stereoscopic video,
the controlling includes
determining a target pixel as a pixel of the first video and a correspondence pixel as a pixel of the second video, which represents a common portion, and
determining the emission luminance of the light source for each local region such that a luminance difference between a first incoming luminance of light reaching the target pixel and a second incoming luminance of light reaching the correspondence pixel is small.
